(19) United States
(12) Patent Application Publication
(10) Pub. No.: US 2024/0277556 A1
(43) Pub. Date: Aug. 22, 2024

(54) MASSAGE SYSTEMS, METHODS, AND APPARATUSES FOR A STABLE AND LEVERAGED BILATERAL PRESSURE POINT MASSAGE

(71) Applicant: BILATHERA Ltd., London (GB)

(72) Inventors: Thomas Michael Gagliano, Marciana Marina (IT); Fabio Huqi, Gaiarine (IT)

(21) Appl. No.: 18/584,889

(22) Filed: Feb. 22, 2024

Related U.S. Application Data
(60) Provisional application No. 63/447,485, filed on Feb. 22, 2023.

(51) Int. Cl. A61H 7/00

(52) U.S. Cl. CPC A61H 7/007; A61H 2201/0153

(57) ABSTRACT

The disclosure describes a system for applying a rotational, translational, and vertical force to a massage area. In some embodiments, the system includes at least one massage tool and at least one linkage. In some embodiments, the linkage is configured to resist motion in a tensile direction. In some embodiments, when the linkage is attached to a massage tool, the resistance allows a user to stabilize the massage tool such that the massage tool can be rotated about the linkage attachment point. In some embodiments, the linkage is attached to a fixed point such as a wall or table at one end and coupled to the massage tool at the other. In some embodiments, two massage tools are joined together by the linkage where their separation is limited and/or resisted by the linkage.

### CROSS-REFERENCE TO RELATED APPLICATIONS

The present application claims the benefit under 35 U.S.C. § 119(c) of U.S. Provisional Patent Application No. 63/447,485, filed Feb. 22, 2023, and titled “MASSAGE SYSTEMS, METHODS, AND APPARATUSES FOR A STABLE AND LEVERAGED BILATERAL PRESSURE POINT MASSAGE,” the contents of which are incorporated by reference herein in their entirety.

### BACKGROUND

Massage therapy is among the oldest and most widespread holistic medicinal practices throughout the world. From culture to culture, it has evolved in many variations, but always with the use of a therapeutic touch as the main way to bring healing and relaxation.

Over the course of thousands of years, therapists integrated ad-hoc tools to massage with different intensities and modalities compared to what was achievable with the human hand alone. Currently, there are various massage tools available. These include passive or active massage tools, as well as massage tools with multiple massaging surfaces or special shapes to massage specific parts of the body. At present, just neck or back massage tools represent $9 billion USD a year in global sales, and this value is growing at 9% CAGR.

There is a multitude of nomenclature and characterization for different types of massage devices and techniques. Among these are acupressure, trigger-point massage, deep-tissue massage, shiatsu massage, myofascial massage, sports massage, lymphatic drainage massage, reflexology, among others. A majority of these characterizations refer to the massage of a localized point on the body. A broad characterization of these types of massages, notably, but not limited to, acupressure and/or trigger-point massage, can be referred to using the generally accepted nomenclature convention of “pressure-point massage,” and/or the preferred generic term “focal-point massage.”

If the massage is desired to have a curative and not just a relaxing function, one often needs to work for longer periods with increased intensity and on designated points that are often difficult to reach. Sometimes the therapist is forced to ask the patient to assume uncomfortable and/or unnatural positions, with the sole aim of exposing the parts of the body to be treated and/or positioning the instruments correctly. This is inherently unstable. As the required pressure point of the massage becomes deeper and more acute, both the patient and therapist are forced to assume an increasingly uncomfortable position.

An example of this is the classic chiropractic procedure when the patient is orientated on his or her side and the therapist is working the lumbar vertebrae with a massage tool (see FIG. 1). This position frequently results in the therapist falling off the patient creating an inherently unsafe and ineffective dynamic. These problems arise from the fact that the conventional pressure-point massage devices are single-knob and single-hand operation instruments. This inherently unstable mode of operation is illustrated in FIG. 2.

There is therefore the need for a massage system that increases both user and patient comfort while increasing safety.

### SUMMARY

In some embodiments, the disclosure is directed to a system for applying vertical and horizontal compression forces during a message. In particular, the system is configured to allow chiropractors, physiotherapists, athletic trainers, massage therapists and or other clinicians to amply and/or direct an applied force to a patient during a therapeutic procedure. In some embodiments, the system comprises one or more of a first massage tool, a second object, and a linkage. In some embodiments, the first massage tool includes a first linkage coupling. In some embodiments, the second object includes a second linkage coupling. In some embodiments, the first massage tool is configured to be connected to the second object by connecting a first linkage end to the first linkage coupling and a second linkage end to the second object.

In some embodiments, the first massage tool further includes a first force input location, a first rotation point, and a first massage location. In some embodiments, a first input force applied to the first force input location is configured to apply tension to the linkage when the first massage location is supported by a first surface and the second linkage end is connected to the second object. In some embodiments, the tension is configured to resist motion of the first rotation point in at least one direction. In some embodiments, the first force input location and the first massage location are configured to move relative to the first rotation point while the tension is applied to the linkage. In some embodiments, the first input force applied to the first force input location is configured to apply a parallel force to the first massage location. In some embodiments, the first input force applied to the first force input location is configured to (additionally) apply a non-parallel force to the first massage location.

In some embodiments, the first force input location is separated from the first rotation point by a first input distance. In some embodiments, the first massage location is separated from the first rotation point by a first massage distance. In some embodiments, the first input distance is greater than the first massage distance. In some embodiments, the first force input location is located at a first input angle relative to the linkage when the linkage is in tension. In some embodiments, the first massage location is located at a first massage angle relative to the linkage when the linkage is in tension. In some embodiments, the first input angle and the first massage angle are different angles.

In some embodiments, the first input force applied along a y-axis to the first force input location is configured to cause a relative y-axis and x-axis force at the first massage location while the linkage is in tension. In some embodiments, (imaginary) lines extending from the first force input location, the first massage location, and the first rotation point create a triangular shape. In some embodiments, a distance between the first force input location and the first massage location define a hypotenuse of the triangular shape. In some embodiments, the first input force is configured apply a resulting output force at the first massage location in a same direction as the hypotenuse while the linkage is in tension.

In some embodiments, the second object includes a second massage tool, wherein the second massage tool includes one or more of a second force input location, a second rotation point, and a second massage location. In some embodiments, a first input force applied to the first force input location and a second input force applied to the second force input location is configured to apply tension to the linkage when the first massage location is supported by a first surface and the second massage location is supported by a second surface.

While the description above is common to all configurations and arrangements presented herein, in some embodiments, the first massage tool is configured to enable the first input force to be applied by a first-hand. In some embodiments, the second massage tool is configured to enable the second input force to be applied by a second hand. In some embodiments, the first force input location includes a handle. In some embodiments, the first massage location includes a massage tip.

In some embodiments, the first massage tool is configured to enable the first input force to be applied by a substantially rigid surface. In some embodiments, the second massage tool is configured to enable the second input force to be applied by the substantially rigid surface. In some embodiments, a user laying on the first massage tool and the second massage tool while the first massage tool and second massage tool are on the substantially rigid surface is configured to create the tension in the linkage. In some embodiments, a user laying on the first massage tool and second massage tool while the first massage tool and second massage tool are on the substantially rigid surface is configured to cause the first massage location and the second massage location to move toward each other while the linkage is in tension.

In some embodiments, a length of the linkage is adjustable. In some embodiments, the adjustable linkage comprises an adjustable rigid linkage (e.g., strap and buckle). In some embodiments, an adjustable linkage comprises an elastic member (e.g., spring, rubber band).

In some embodiments, the first force input location includes a deformable curved surface. In some embodiments, the first massage location includes a rigid massage tip. In some embodiments, the first force input location includes a rigid curved surface. In some embodiments, the first massage location includes a rigid massage tip.

In some embodiments, the system comprises a rack assembly comprising a first rack and a second rack. In some embodiments, a plurality of first massage tools are coupled to the first rack. In some embodiments, a plurality of second massage tools are coupled to the second rack.

In some embodiments, the system includes a kit comprising a combination of one or more structures described herein.

### DRAWINGS DESCRIPTION

FIG. 1 shows prior art tools.

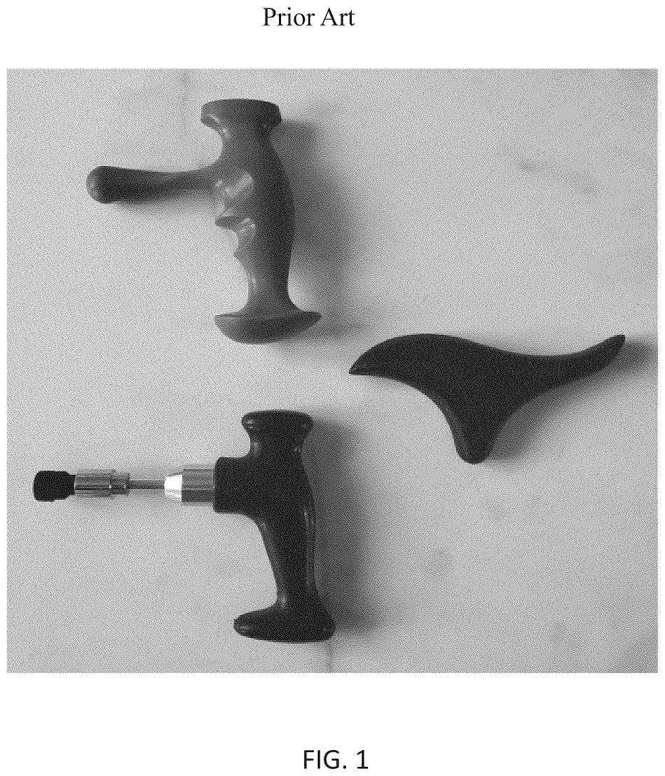

FIG. 2 illustrates the instability of the prior art.

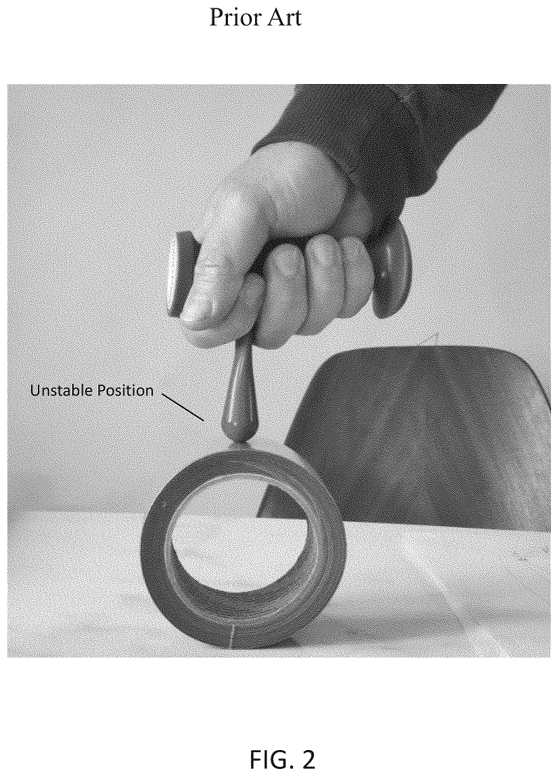

FIG. 3 shows a principal axis of a linkage as well as frames and massage heads according to some embodiments.

FIG. 4 shows a simplified diagram of system components according to some embodiments.

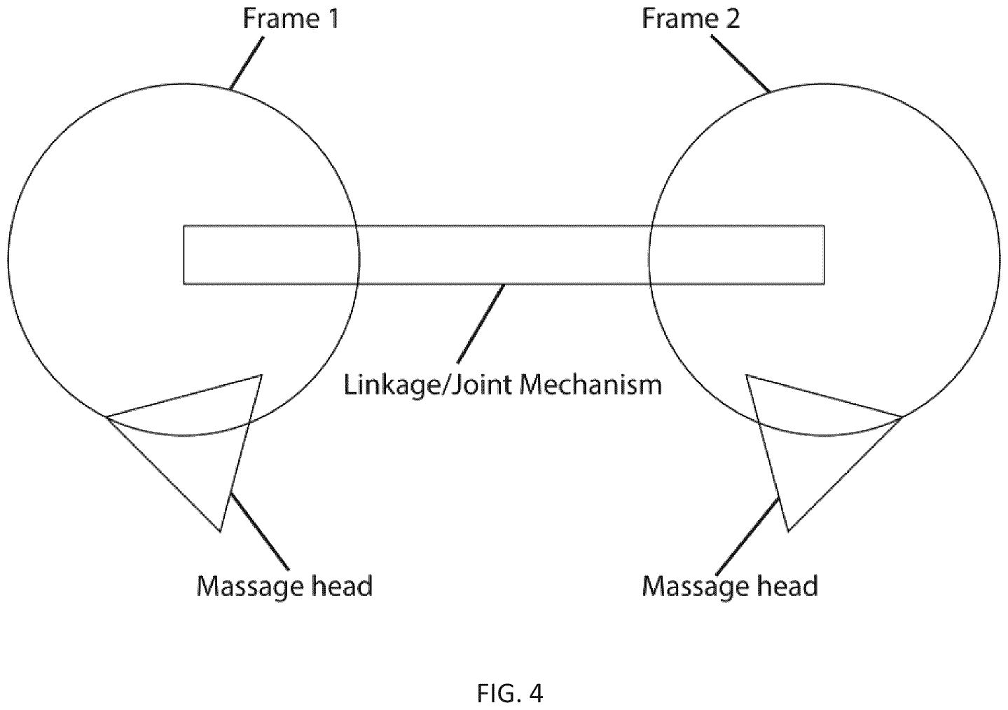

FIG. 5 illustrates translated force through the frames to the massage heads according to some embodiments.

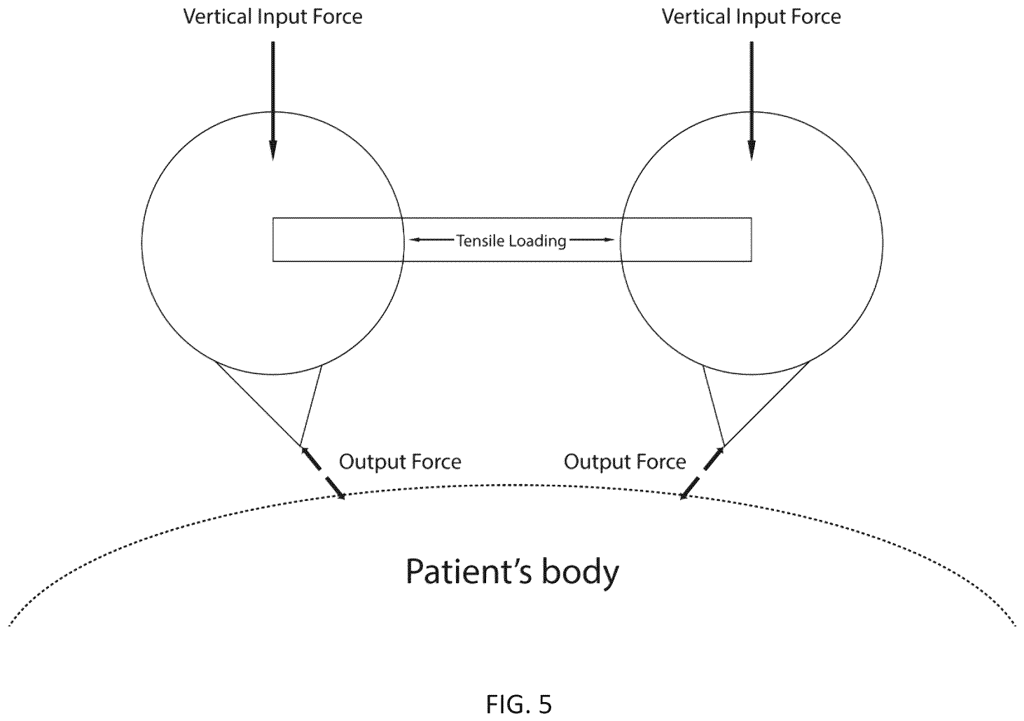

FIG. 6 shows a view of frames in a parallel longitudinal handle axis configuration according to some embodiments.

FIG. 7 shows a T-bar frame configured to be connected by a linkage with multiple degrees of freedom according to some embodiments.

FIG. 8 illustrates two T-bar frames connected by a linkage according to some embodiments.

FIG. 9 depicts an intersecting longitudinal handle axis system configuration according to some embodiments.

FIG. 10 shows the system's ability to generate a rotational force about the linkage axis according to some embodiments.

FIG. 11 illustrates a strap used as an adjustable linkage according to some embodiments.

FIG. 12 depicts a convex relief feature portion of a linkage coupling configured to prevent interference between the linkage and frame according to some embodiments.

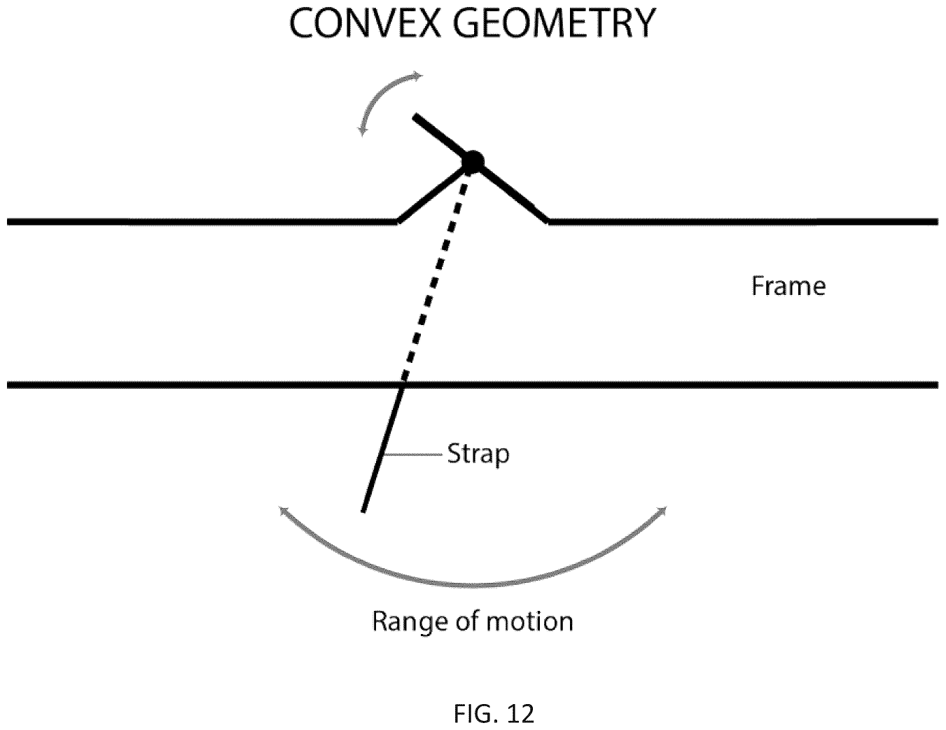

FIG. 13 depicts a concave relief feature portion of a linkage coupling to configured to prevent interference between the linkage and frame according to some embodiments.

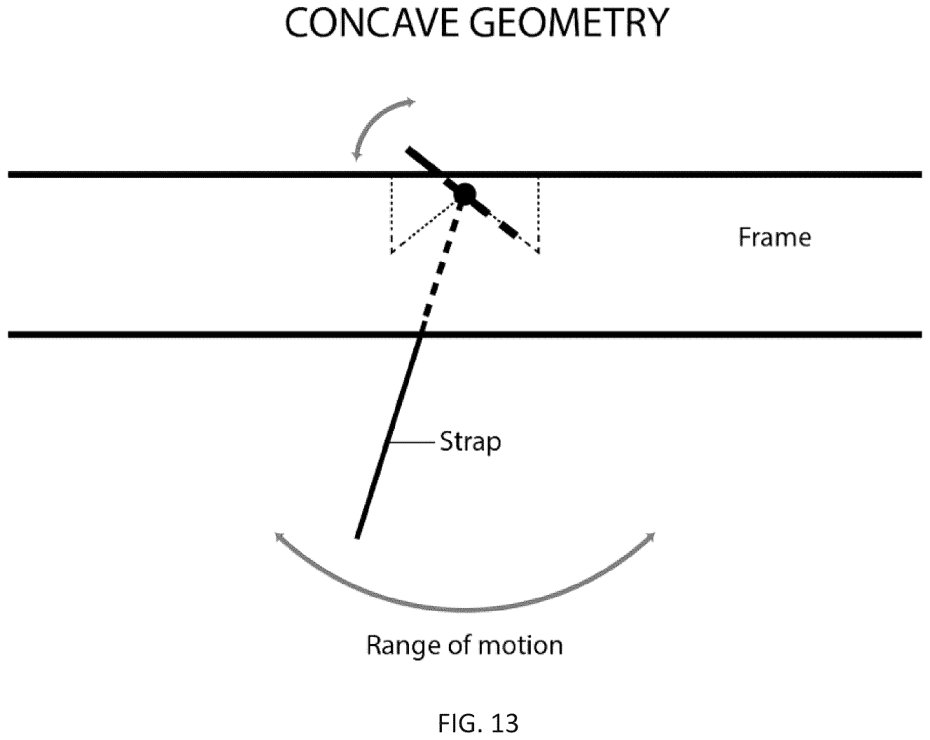

FIG. 14 illustrates a 5.5 degrees of freedom concept according to some embodiments.

FIG. 15 shows an adjustable linkage comprising a strap buckle according to some embodiments.

FIG. 16 depicts an adjustable linkage feature that includes rope-hooks according to some embodiments.

FIG. 17 shows an adjustable linkage feature that includes Velcro® straps according to some embodiments.

FIG. 18 illustrates an adjustable linkage feature that includes a knot holder according to some embodiments.

FIG. 19 depicts an adjustable linkage feature that includes interchangeable links according to some embodiments.

FIG. 20 illustrates an adjustable linkage feature that includes a linear feed (e.g., screw feed) according to some embodiments.

FIG. 21 shows an adjustable linkage feature that includes coiling spoil integrated into the linkage and/or frame handle according to some embodiments.

FIG. 22 shows an adjustable linkage feature that includes a spring according to some embodiments.

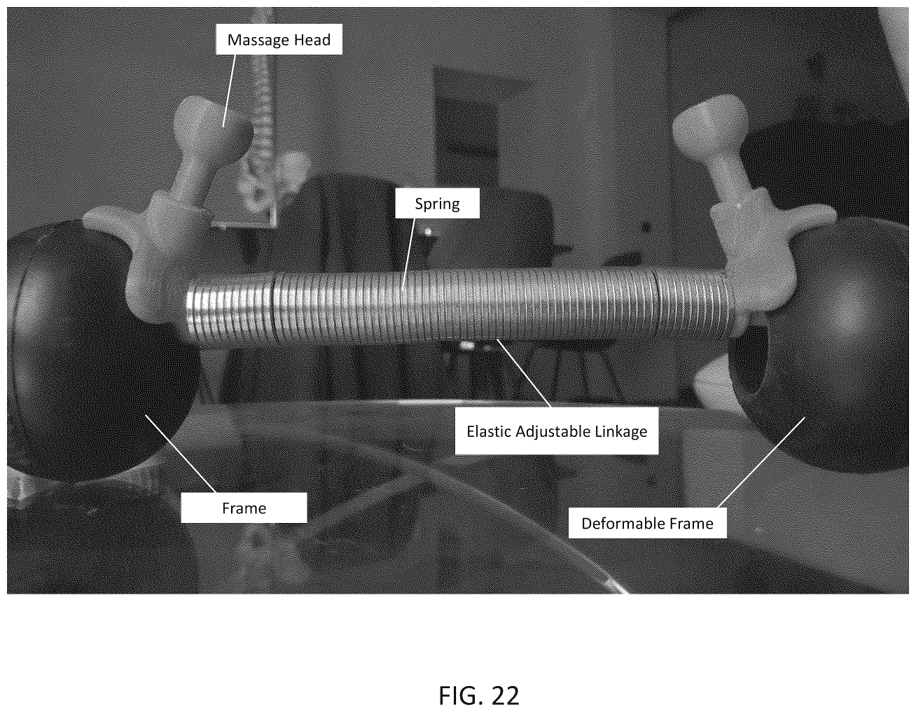

FIG. 23 illustrates a backhand support structure integrated into a curved T-frame according to some embodiments.

FIG. 24 shows a backhand support structure integral to a frame according to some embodiments.

FIG. 25 illustrates BHS input forces and resulting massage head output forces according to some embodiments.

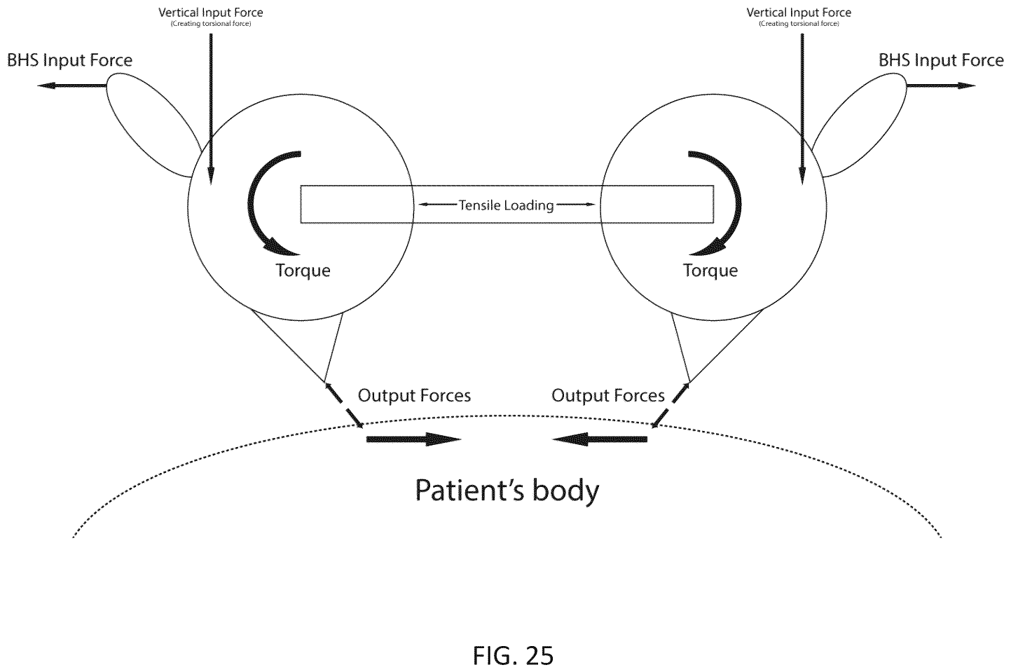

FIG. 26 illustrates an independent BHS coupled to the linkage according to some embodiments.

FIG. 27 depicts a user defined balance achieved by tensile loading through a hollow portion according to some embodiments.

FIG. 28 illustrates user defined balance achieved by tensile loading along the principal axis according to some embodiments.

FIG. 29 depicts the horizontal distance from a handle centerline to the linkage coupling at a range of approximately 2 cm to 7 cm according to some embodiments.

FIG. 30 shows a non-limiting example of geometrical criteria that includes linkage and/or linkage coupling located in a range between a longitudinal axis of the handle and a midpoint between the longitudinal axis and the massage head tip according to some embodiments.

FIG. 31 shows a non-limiting example of a system kit according to some embodiments.

FIG. 32 shows a surface mount attached to linkage and a frame according to some embodiments.

FIG. 33 illustrates the frame rotated to a different massage head on the frame according to some embodiments.

FIG. 34 depicts a simplified drawing of a frame including a compressible member according to some embodiments.

FIG. 35 shows a picture of a frame including a compressible member according to some embodiments.

FIG. 36 show resulting applied forces to the compressible member in a self-massage arrangement according to some embodiments.

FIG. 37 show resulting torsional forces to a patient's body during the self-massage according to some embodiments.

FIG. 38 illustrates a non-linear surface support member according to some embodiments.

FIG. 39 depicts a plurality of frames attached to two racks according to some embodiments.

FIG. 40 illustrates a telescoping and/or articulating mounting stem according to some embodiments.

FIG. 41 illustrates the interchangeability of various system components according to some embodiments.

FIG. 42 depicts a non-limiting system computer arrangement according to some embodiments.

FIG. 43 shows an extended portion of the frame with two hollow portions according to some embodiments.

FIG. 44 shows an extended portion of the frame with a convex geometry according to some embodiments.

FIG. 45 illustrates another view of the extended portion of the frame with a convex geometry according to some embodiments.

FIG. 46 depicts the interaction between the linkage and the convex geometry according to some embodiments.

FIG. 47 shows engagement between the linkage and the convex geometry according to some embodiments.

FIG. 48 shows another view of engagement between the linkage and the convex geometry according to some embodiments.

FIG. 49 illustrates a linkage connected between two frames that each have convex geometry according to some embodiments.

FIG. 50 illustrates BHS translational and rotational adjustability according to some embodiments.

FIGS. 51A-51C show views of an orbital frame system according to some embodiments.

FIGS. 52A-52B depict internally coupled massage heads attached to orbital frames according to some embodiments.

FIGS. 53A-53B illustrate externally coupled massage heads attached to orbital frames according to some embodiments.

FIGS. 54A-54B illustrate different massage head attached to different orbital frames according to some embodiments.

FIG. 55 shows and exploded orbital frame top view according to some embodiments.

FIG. 56 shows an exploded orbital frame isometric top left view according to some embodiments.

FIG. 57 depicts an exploded orbital frame isometric top right view according to some embodiments.

FIGS. 58A-58D illustrate and adjustment method for an orbital frame according to some embodiments.

FIGS. 59A-59B depict a back hand support (BHS) portion of an orbital frame according to some embodiments.

FIGS. 60A-60C illustrate a bridge portion of an orbital frame according to some embodiments.

FIGS. 61A-61D show features of a linkage coupling protrusion according to some embodiments.

FIGS. 62A-62E show various features of a massage head coupling according to some embodiments.

FIGS. 63A-63C depict views of a handle portion of an orbital frame according to some embodiments.

FIGS. 64A-64C show different views of a handle thrust plate according to some embodiments.

FIGS. 65A-65C illustrate a bridge thrust plate according to some embodiments.

FIGS. 66A-66C illustrate a thrust plate knob according to some embodiments.

FIG. 67 depicts a second handle thrust plate according to some embodiments.

FIGS. 68A-68C show a bridge lock plate according to some embodiments.

FIGS. 69A-69C show view of a knob plug according to some embodiments.

FIG. 70 shows various massage head tips according to some embodiments.

FIGS. 71A-71C illustrate various features of a roller frame assembly according to some embodiments.

FIG. 72 illustrates resultant forces from a user laying on a roller frame assembly according to some embodiments.

FIG. 73 illustrates resultant forces from a user laying on a deformable frame assembly according to some embodiments.

FIG. 74 illustrates resultant forces from a user pushing on the handles of an orbital frame assembly according to some embodiments.

FIG. 75 shows the resulting force from force applied to both the handle and the BHS of an orbital frame according to some embodiments.

FIG. 76 depicts the resulting force where an axis of the handle includes the point of rotation according to some embodiments.

FIGS. 77A-77E shows various locations for components of a modular frame according to some embodiments.

### DETAILED DESCRIPTION

The present invention relates to a system for the application of a controlled and simultaneously leveraged bilateral pressure point massage on various parts of the body according to some embodiments.

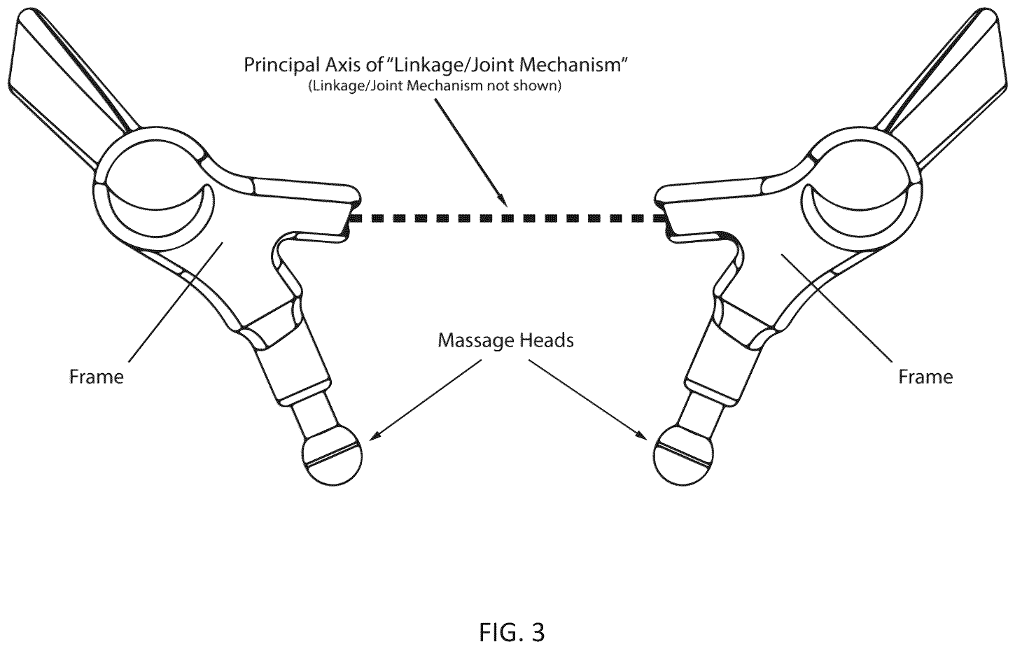

In some embodiments, the device comprises at least two handheld massage frames connected by one or more linkages and/or joint mechanisms (each collectively referred to as a “linkage”). In some embodiments, a linkage includes more than one free motional degree of freedom. In some embodiments, a linkage is fixed and/or is configured to support tensile loading along its principal axis. A principal axis is defined as a virtual line drawn between the two linkage attachment points on each respective frame while the linkage is at a maximum tension: see FIG. 3.

In some embodiments, one or more frames include one or more massage head receptacles configured to receive and/or couple to one or more massage heads. In some embodiments, one or more frames include a solid and/or rigid structure, where the structure components are each configured to bend less than 5° relative to another component. In some embodiments, one or more frames include an elastic and/or non-rigid structure configured to enable one or more frame components to bend more than 5° relative to another component.

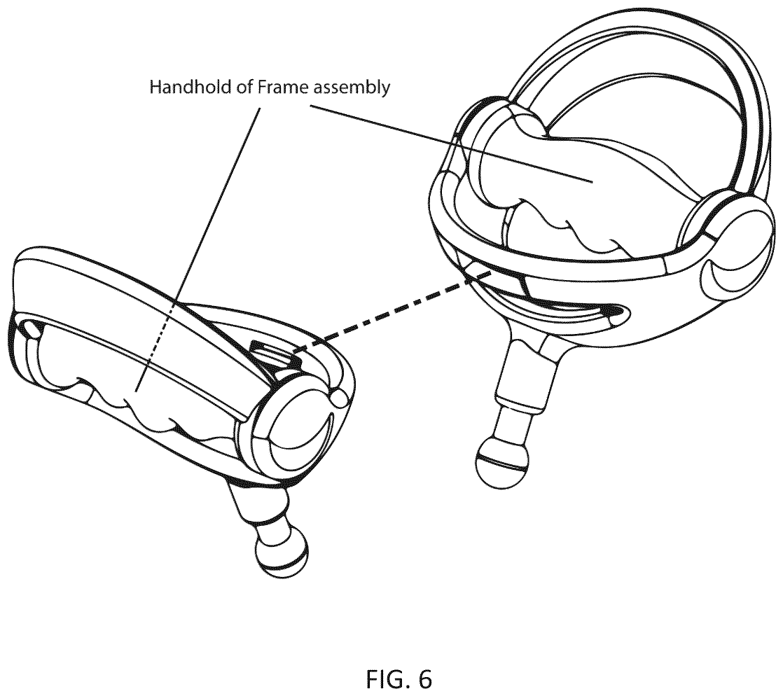

In some embodiments, a non-rigid structure includes a multibar. In some embodiments, a multibar includes one or more springs and/or one or more levers. In some embodiments, the principal axis of the linkage and a massage head axis lies in a plane perpendicular to the axis of the frame handle and/or along a center point of the frame handle axis (see FIG. 6).

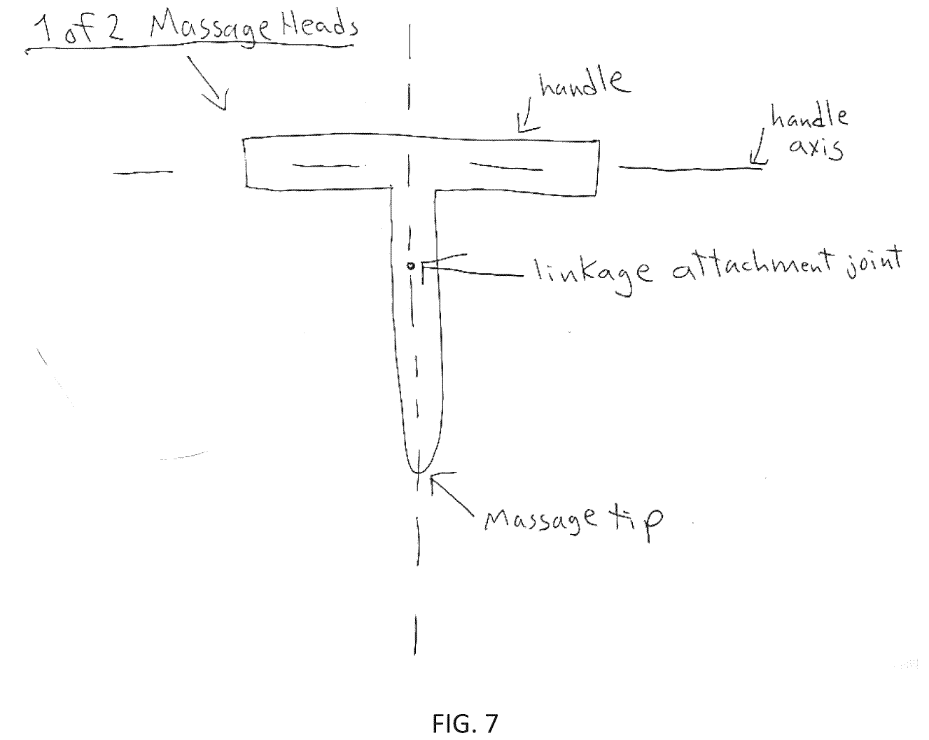

In some embodiments, the system includes two T-bar frames connected by a linkage with multiple degrees of freedom as shown in FIG. 7. In some embodiments, the system is configured to enable a user (e.g., chiropractor) to implement a simultaneous and/or orchestrated bilateral pressure point massage using two frames (one in each hand) connected by a linkage. In some embodiments, the system is configured to enable a chiropractor (user) working on a lumbar vertebrae and/or support muscles to allow a patient to be left supine and/or in a more relaxed and stable position, as the system provides the benefit of enabling a user to massage both sides of the vertebrae in a stable and safe controlled manner. In some embodiments, the system is configured to enable one side of the device to be held (“anchored”) in a substantially stable and/or stationary position while the alternative side is used for the actively operative pressure point massage. In some embodiments, the system is configured to enable a first frame to remain stationary while enabling tensile loading of the linkage and/or movement of the second frame.

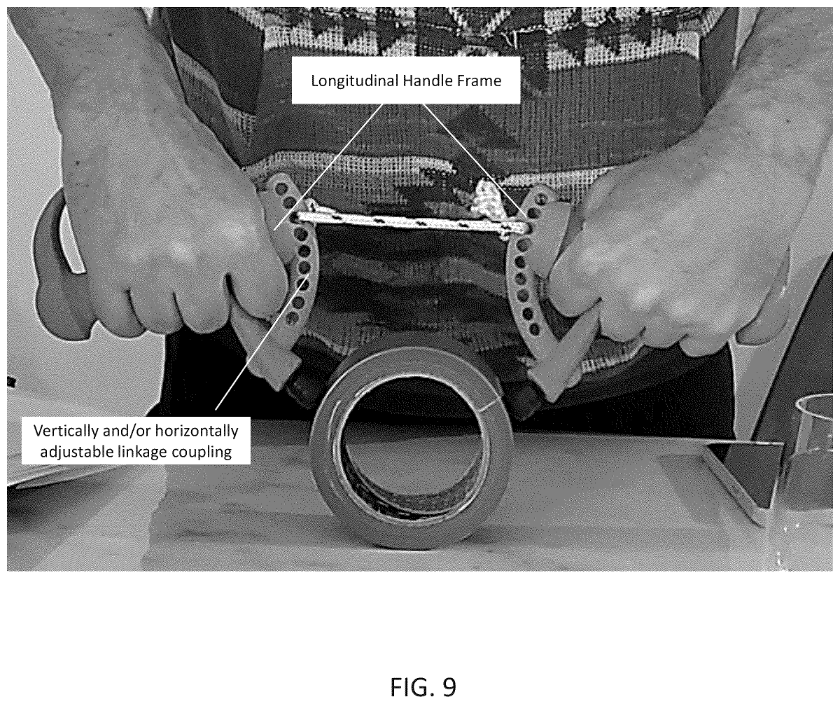

In some embodiments, one or more frames comprise one or more (e.g., a plurality) of linkage couplings configured to enable a user to rotate one or more handles to a different orientation relative to the linkage and/or another frame. In some embodiments, one or more frames include an orthogonal linkage coupling configured to orient the handles substantially perpendicular to the linkage, where a user's hands are oriented with both respective palms facing inwards towards the linkage when holding both handles (see FIG. 6). In some embodiments, one or more frames include an orthogonal linkage coupling configured to orient the handles substantially parallel to the linkage, where a user's hands are oriented with both respective palms facing perpendicular to the linkage when holding both handles (see FIG. 9). In some embodiments, a perpendicular (orthogonal) orientation of the hands can reduce the efficacy of massage articulation. In some embodiments, one or more linkage couplings include vertical linkage couplings configured to move the linkage in a vertical (i.e., toward/away from the patient) direction. In some embodiments, the vertical linkage couplings are configured to increase or decrease the amount of torsion at the massage heads by increasing the rotational lever arm (see FIG. 9).

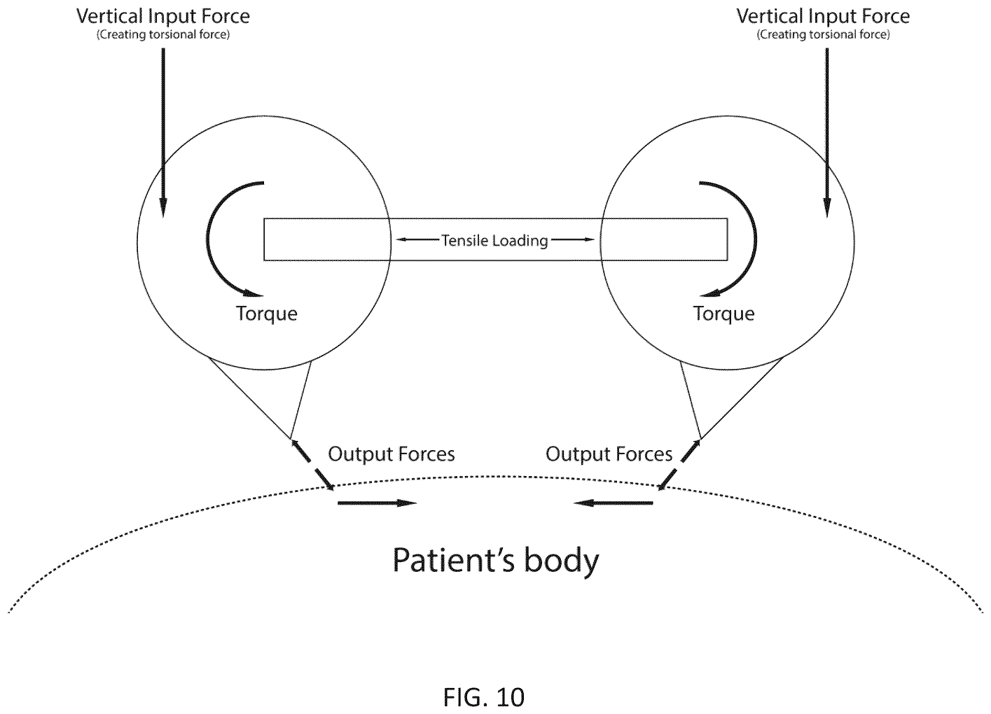

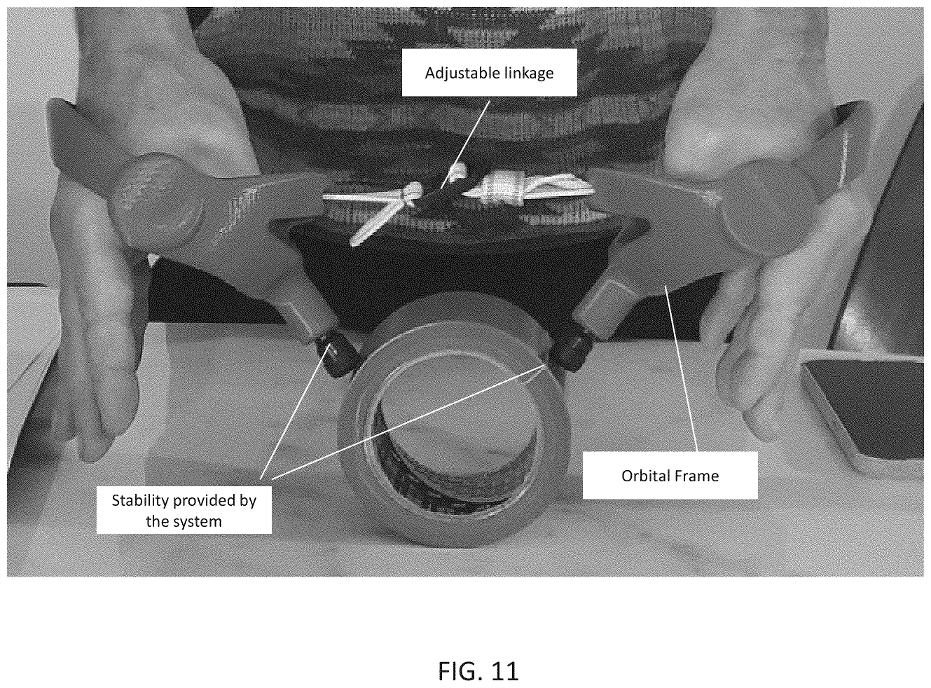

In some embodiments, the system is configured to enable a user to apply a torsional (rotational) force about the linkage principal axis (see FIG. 10). In some embodiments, the system is configured to enable a user to generate both torsional force and a downward (i.e., into the patient) force simultaneously. In some embodiments, the linkage is an adjustable linkage (see FIG. 11, e.g., a strap) configured to enable the linkage to extend, contract, and/or lock into a new position. In some embodiments, the adjustable linkage is configured to enable the handles to be positioned further outward relative to massage heads maintained in a same position. In some embodiments, the adjustable linkage is configured to increase (i.e., longer linkage) or decrease (i.e., shorter linkage the amount a torsional force at the massage heads for a same vertical force on the handles. In some embodiments, a linkage includes, but is not limited to, one or more of a mechanical linkage, a rope, a cord, a band, a strap, an elastic member, and/or a rigid member with one or more degrees of freedom joints.

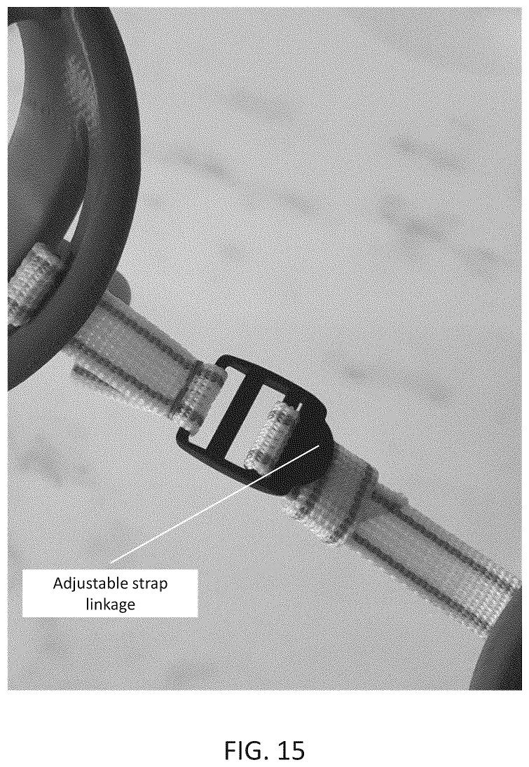

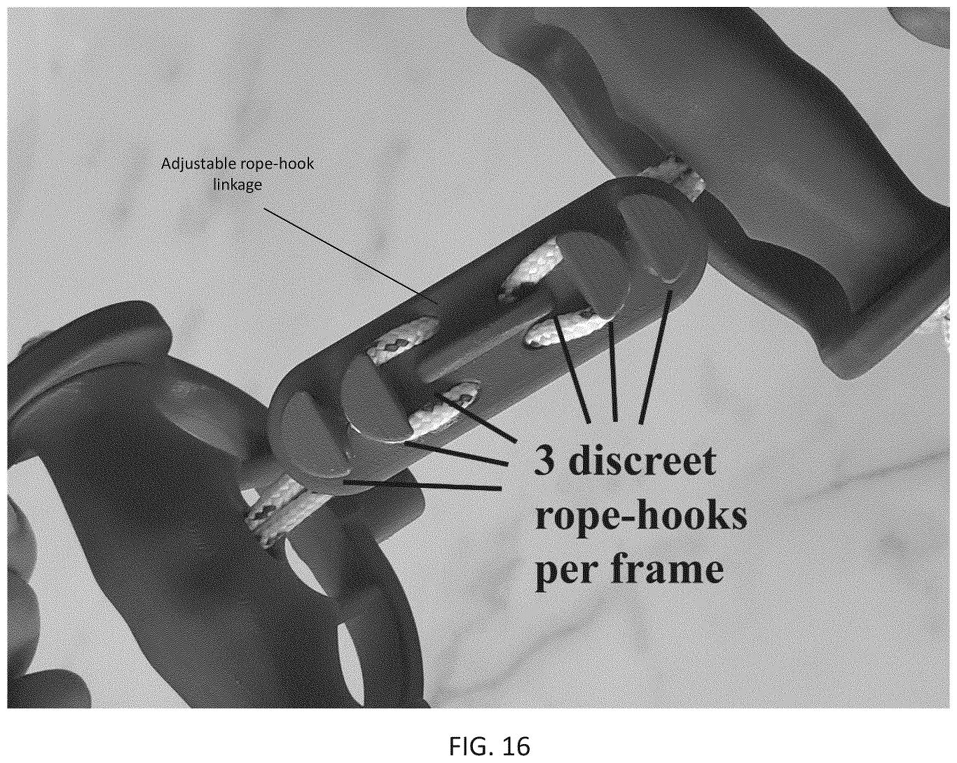

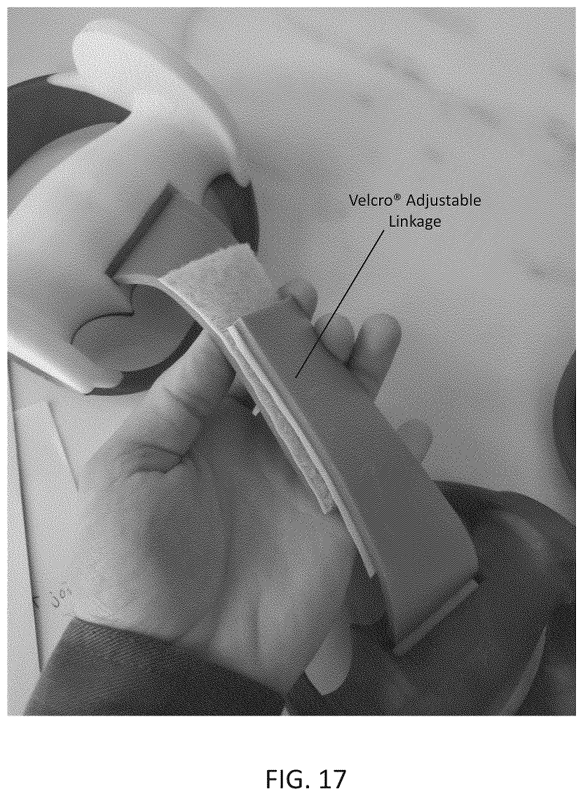

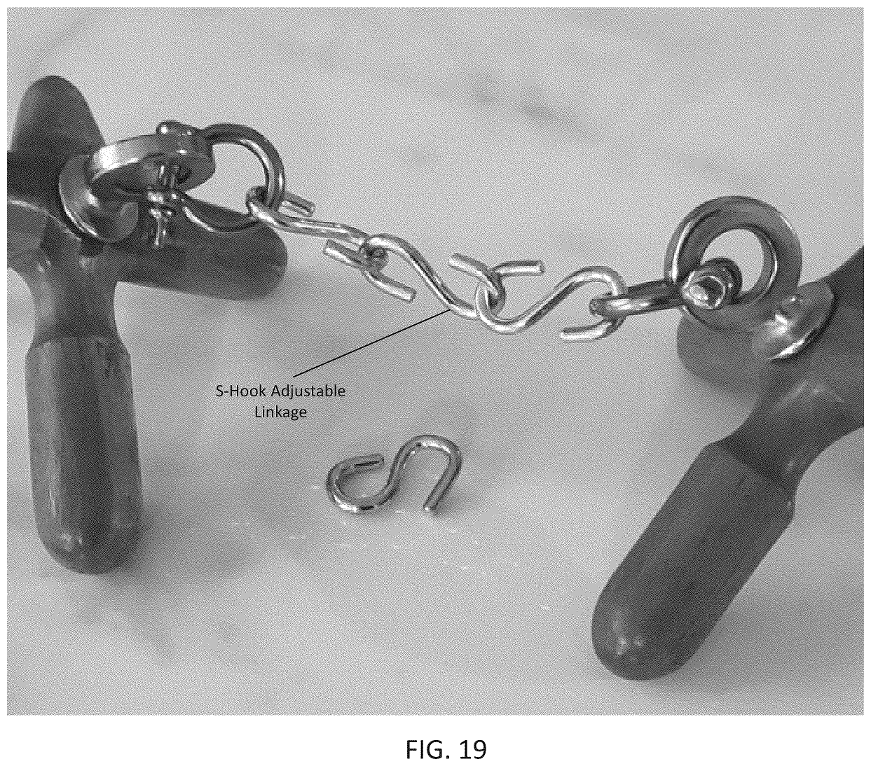

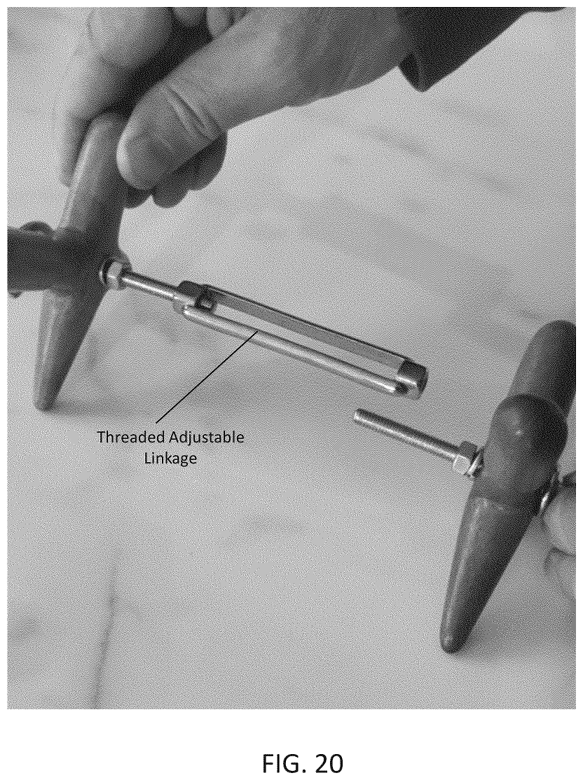

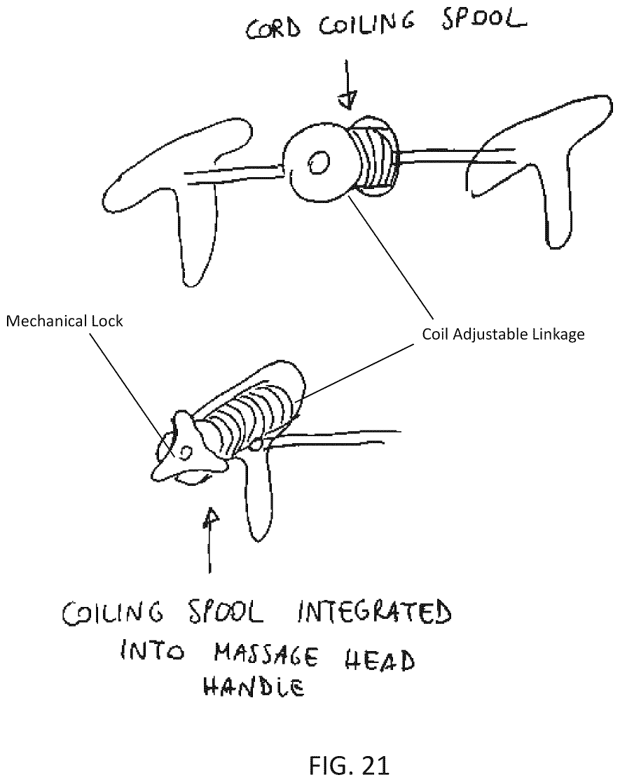

FIGS. 15-21 illustrate various adjustable linkage mechanisms according to some embodiments. In some embodiments, an adjustable linkage includes, but is not limited to, one or more of a (e.g., mechanical, “slinky-type”) spring, an elastic member (e.g., with a pre-defined limit to stretch), a hybrid elastic member comprising an internal rigid cable resulting in a rigidity along a specified linear path within the elastic member, and/or a hybrid combination of some embodiments presented herein. FIG. 21 shows a linkage cord coiling spool located between two T-shaped massage heads, where the cord coiling spool is configured to expand or retract in response to input force by the user. FIG. 21 also shows the coiling spool integrated into the handle of the T-shaped massage head, where the spool can be fixed in position by a spool lock, which includes a mechanical lock in this non-limiting embodiment. As mentioned previously, features from any figure is readily incorporable into other structures.

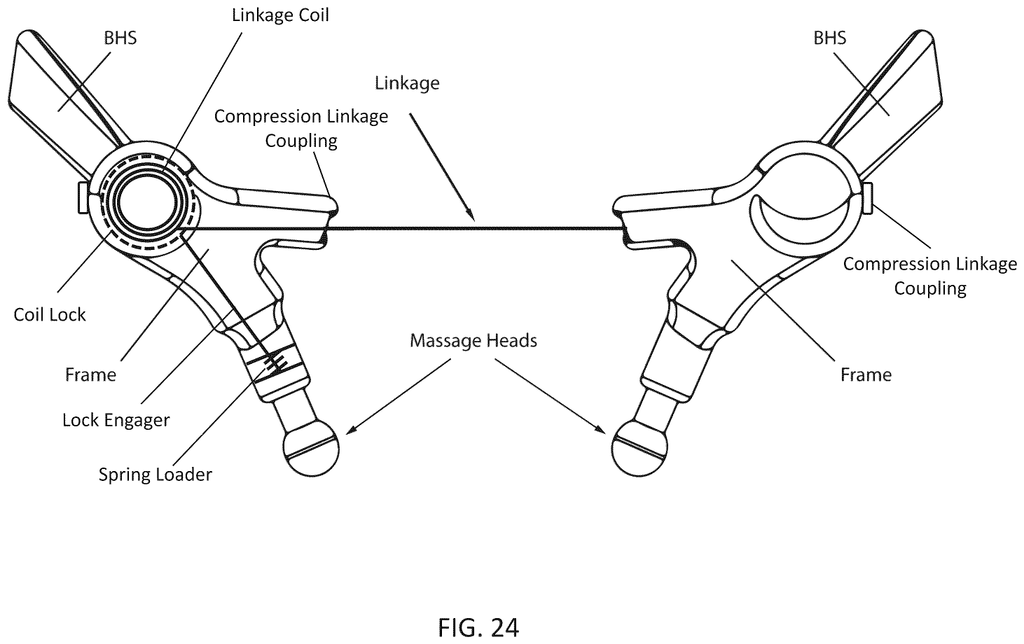

As a non-limiting example, FIG. 24 shows a linkage coil integrated into one or both orbital frames. In some embodiments, the linkage coil is configured to enable the linkage to expand or contract by applying or releasing tensile load. In some embodiments, the linkage coil is a spring-loaded coil. In some embodiments, the linkage coil includes a coil lock configured to prevent rotation of the linkage coil when engaged with the lock engager. In some embodiments, the lock engager is coupled to a spring loader configured to move the lock engager into engagement with the coil lock when compressed, and/or release the coil lock when decompressed. In some embodiments, the spring loader is located within the massage head stem.

In some embodiments, the massage head includes the spring loader. In some embodiments, when the massage head is attached to the massage head stem, and no force is applied to the massage head (e.g., the frame is held freely), the spring loader is uncompressed and the coil lock allows the linkage to expand and contract freely. In some embodiments, when a force is applied to the massage head, the lock engager engages the coil lock, preventing expansion and/or contraction of the linkage during a massage.

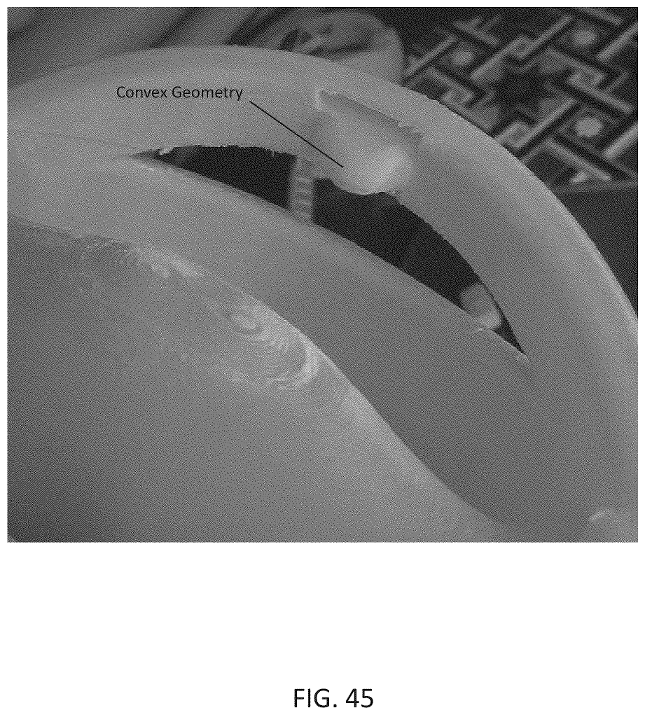

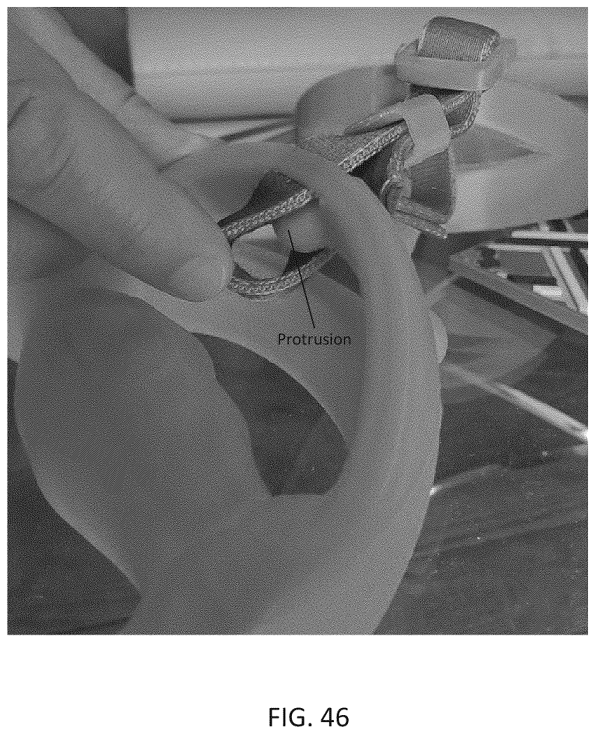

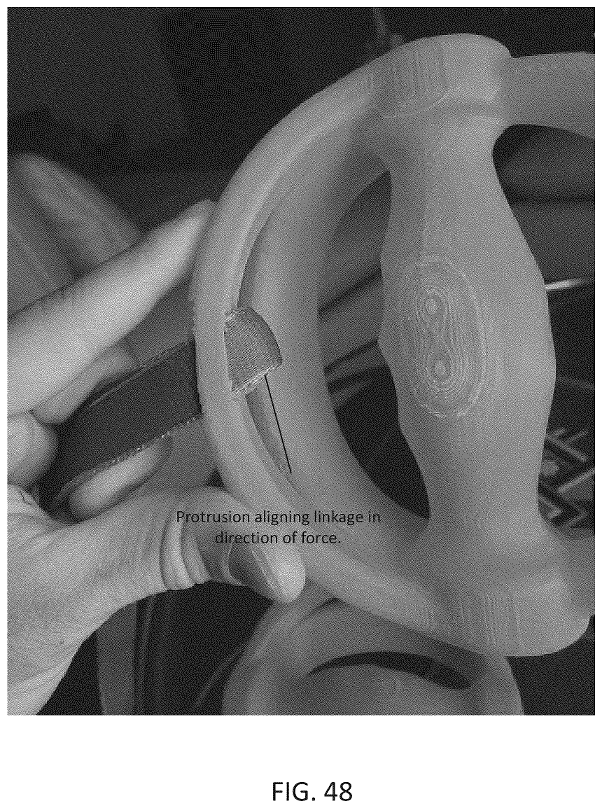

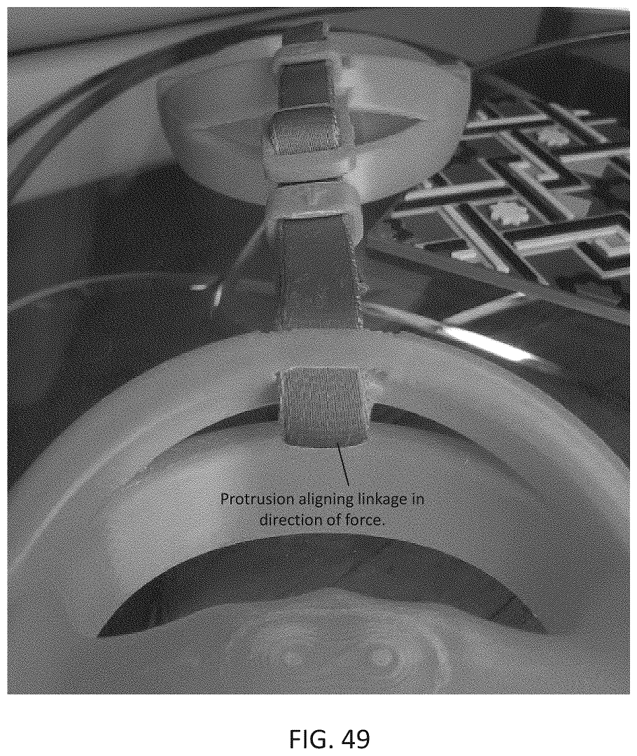

In some embodiments, (e.g., where a band or strap is utilized for the linkage/joint mechanism) each frame has one or more relief features proximate the linkage attachment point to facilitate case of rotational movement of the linkage. In some embodiments, the one or more relief features include one or more of an external convex geometry in the linkage coupling portion of the frame. FIGS. 45-50 illustrate various views of convex geometry according to some embodiments. In some embodiments, the convex geometry comprises a protrusion between two linkage apertures, where the protrusion extends at least partially towards the handle. In some embodiments, the protrusion is configured to engage at least a portion of the linkage. In some embodiments, the protrusion is configured to align at least a portion of the linkage in the direction of tensile force (see FIG. 48 and FIG. 49). In some embodiments, the linkage coupling portion of the frame includes an outward extending bridge structure portion of frame configured to couple to the strap. In some embodiments, the outward extending portion is configured to act as a massage head. In some embodiments, the frame (e.g., the outward extending portion) includes one or more massage head protrusions configured to apply different amounts of pressure.

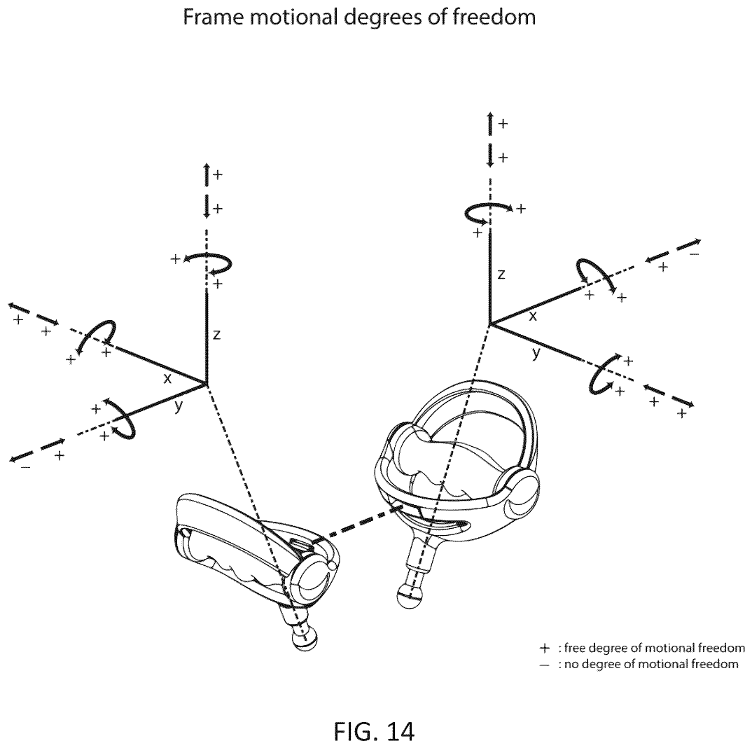

In some embodiments, the linkage is configured to enable one or more frames to move in any direction (i.e., in any degree of freedom) except extension tensile loading along the principal axis. In some embodiments, the linkage joint mechanism includes 5.5 degrees of freedom, where the only fixed degree of freedom is translational motion in the outward direction along the principal axis of the linkage when extended to its limit, while translation in the other direction of the same axis is free: thus, the definition of 5.5 (out of 6 total) motional degrees of freedom. FIG. 14 illustrates the 5.5 degrees of freedom concept according to some embodiments.

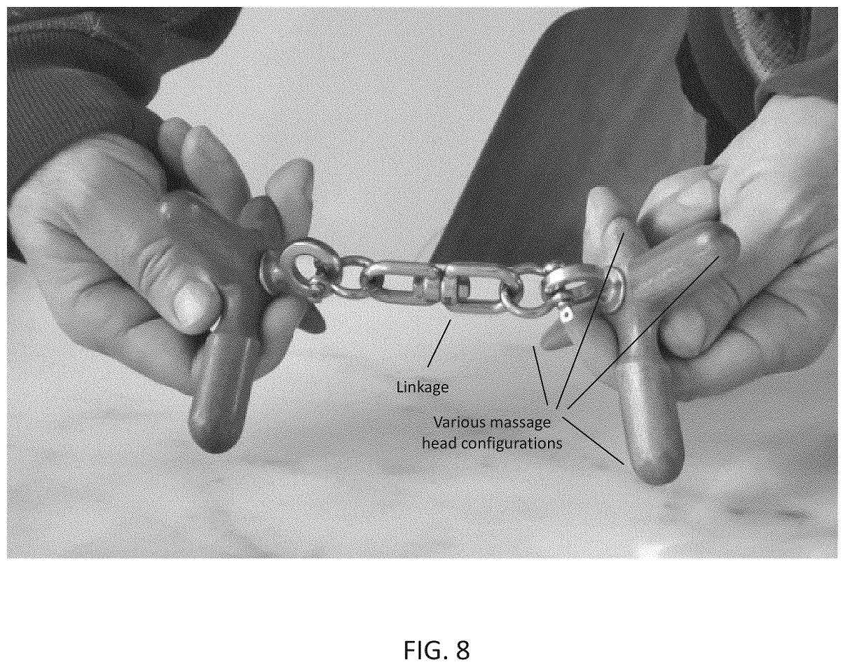

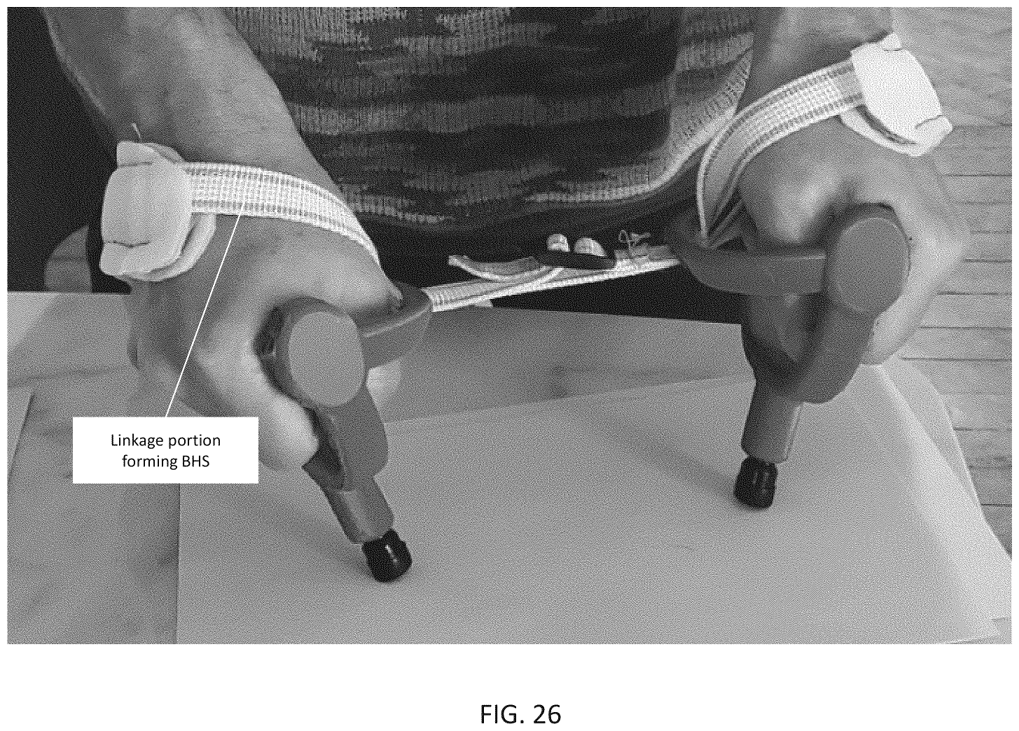

In some embodiments, the system includes one or more wrist straps comprising one or more linkage couplings (see FIG. 26). In some embodiments, the wrist straps are not fixed to the frame, but are configured to couple and/or be fixed to a user's wrist, such that the linkage limits wrist movement in the tensile direction, and vice versa. In some embodiments, the system includes one or more separate frames configured to be used in conjunction with the wrist straps. In some embodiments, the system includes both a linkage wrist strap and a BHS. The one or more frames include any frame described herein, as all features and/or components according to some embodiments are understood to be readily incorporated with any other features and/or components according to some embodiments in this disclosure. As a non-limiting example, a T-shaped, multi-head frame, such as shown in FIG. 8, for example, is configured to be coupled to an orbital frame shown in FIG. 6 using any of the linkages shown in any of the figures according to some embodiments. In another non-limiting example, the left longitudinal handle frame in FIG. 9 may be combined with the right orbital frame in FIG. 11, with any linkage described herein connecting the two. Therefore, restriction to a particular arrangement shown in any one figure and/or groups of figures is not appropriate for determining the metes and bounds of the system. Thus, features from any figure (e.g., linkage coupling) can be combined with, replace, and/or be integrated with features from any other figures, and the system may include different types of massage tools coupled together.

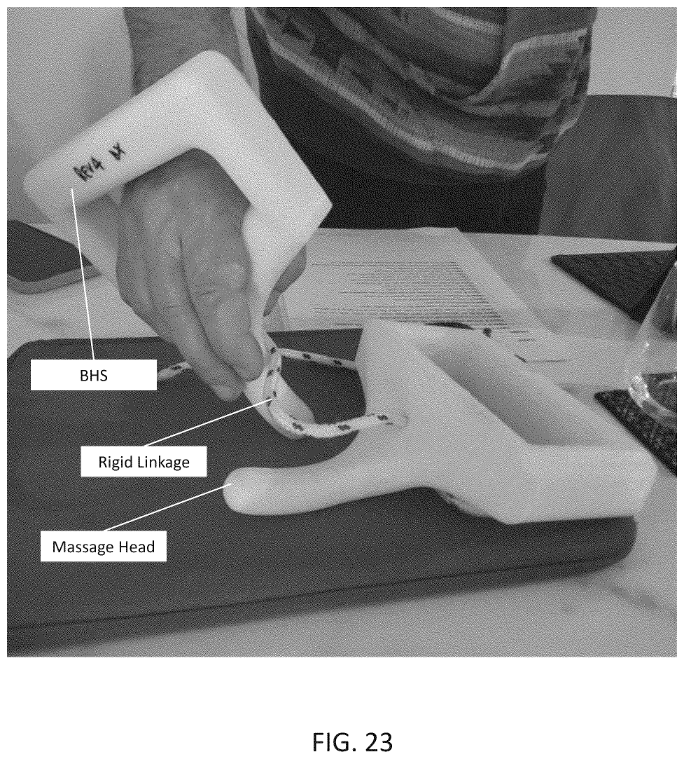

In some embodiments, each frame includes a backhand support (BHS) structure configured to engage with a portion of the user's extremities above the fingers (e.g., back of the hand, wrist, forearm, and/or either side of each). The BHS is integrated in one or more frames described herein according to some embodiments. FIG. 23 illustrates a backhand support structure integrated into a curved T-frame according to some embodiments. In some embodiments, the BHS is configured to enable an operator to apply a horizontal force (e.g., outward) using a portion of an extremity above the fingers while simultaneously applying a vertical (e.g., downward) force. In some embodiments, the BHS is configured to enable a user to apply horizontal force through articulation of the wrist. In some embodiments, the outward horizontal force at the BHS is configured to result in an inward horizontal force at the massage head. In doing so, considering an example of working on vertebral muscles according to some embodiments, the system is configured to apply a vertical downward force on each respective sides of the spine and/or a torsional inward clamping force to each respective lateral sides of the spine. In some embodiments the system is configured to enable a user to apply a translational and rotational moment with the BHS in addition to having freedom of articulation of each pressure point frame.

In some embodiments, at least a portion of the BHS comprises a deformable structure. In some embodiments, the deformable structure is configured to conform the shape of a surface (e.g., back of hand) in one or more directions. Non-limiting examples of at least a portion of the deformable structure includes a cushion and/or strap. In some embodiments, the deformable structure includes an elastic material. In some embodiments, the deformable structure is configured to enable a BHS to conform to a plurality of hand sizes and/or shapes. In some embodiments, the deformable structure is removably coupled to the BHS, and/or is configured to be replaced with at least one other deformable structure of different size and shape. In some embodiments, one or more portions of a frame include a textured surface.

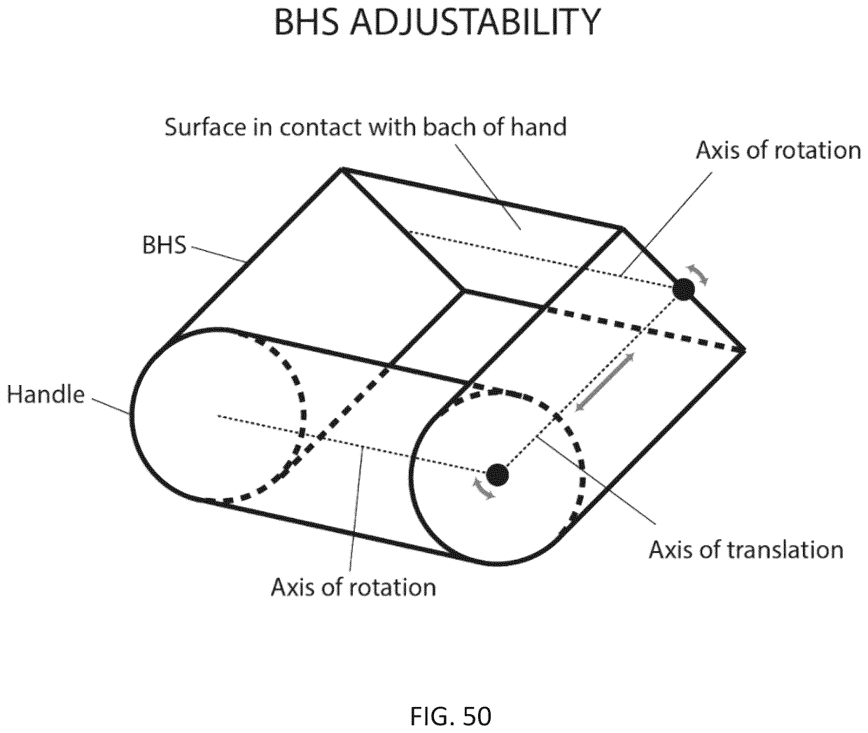

In some embodiments, the deformable structure includes one or more BHS joints. In some embodiments, the one or more BHS joints are configured to enable the deformable structure to change its structural shape (i.e., articulate and/or extend into a new shape). In some embodiments, the deformable structure includes one or more telescoping arms. In some embodiments, the one or more BHS joints and/or telescoping arms include one or more joint locks configured to lock the one or more BHS joints in a fixed position after manipulation to create a rigid structure. In some embodiments, the BHS includes rotation and/or translational adjustment. In some embodiments, the BHS includes at least two points of rotational adjustment and at least one translational adjustment. FIG. 50 illustrates BHS translational and rotational adjustability according to some embodiments. In some embodiments, the BHS is integral to the frame. In some embodiments, the BHS is separable from the frame. In some embodiments, the BHS is independent of the frame. In some embodiments, the BHS is configured to couple to the linkage.

FIG. 26 illustrates an independent BHS coupled to the linkage according to some embodiments. In this non-limiting example according to some embodiments, the BHS and the linkage include a continuous structure. In some embodiments, the linkage is configured to pass through at least one hollow portion of the frame without being rigidly fixed to the frame. In some embodiments, the linkage includes one or more mechanical stops configured to prevent at least a portion of the linkage from passing through the at least one hollow portion, thereby limiting the travel of the linkage through a hollow portion in one or more directions. In some embodiments, mechanical stops are adjustable to different position on the linkage. In some embodiments, at least one hollow portion comprises one or more mechanical stops. In some embodiments, at least one mechanical stop on one side of a hollow portion is configured to enable tensile engagement of the linkage without engaging the BHS for additional torsional massage force. In some embodiments, at least one mechanical stop on another side of the hollow portion is configured to keep the requisite amount of strap for the BHS from pulling through the hollow portion. As previously mentioned, the system is configured to enable a combination of structural features and/or components such as the backhand support for integration into one or more frame types and/or individual frames, so the system is not limited to any single description or figure according to some embodiments.

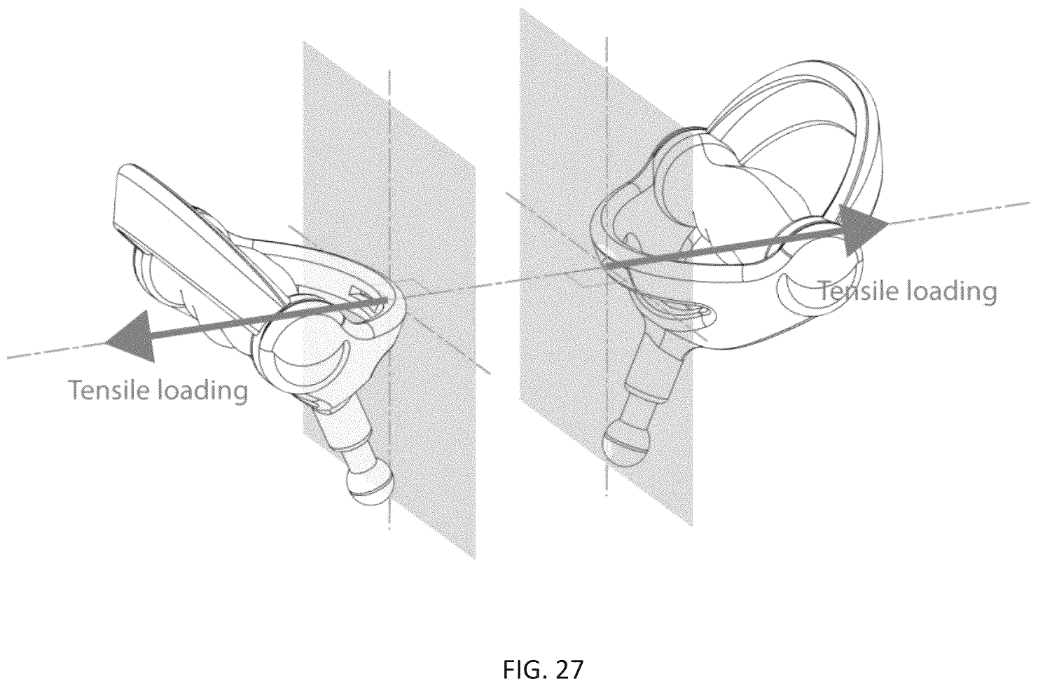

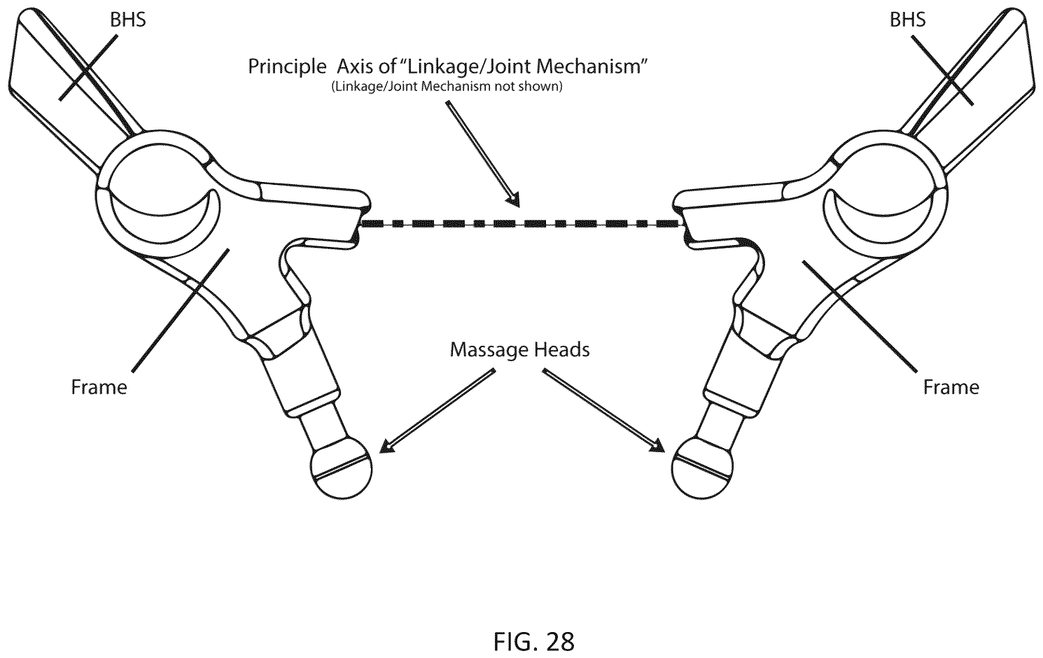

In some embodiments, the various geometrical configurations provide the benefit of enabling a user to define a balance of one or more of vertical output force application to the patient, output torsional clamping force generation and application to the patient, and efficacy of massage articulation. In some embodiments, the user defined balance is achieved by one or more geometrical criteria associated with the device. In some embodiments, geometrical criteria include the system's “starting position.” In some embodiments, the starting position includes a geometrical equilibrium position of each respective frame that is achieved when the linkage joint mechanism is extended and put into tensile loading from each respective linkage coupling along the principal axis by means of the tensile loading being applied to one or more frames at the linkage coupling (and/or hollow portion) attachment point (see FIGS. 27 and 28).

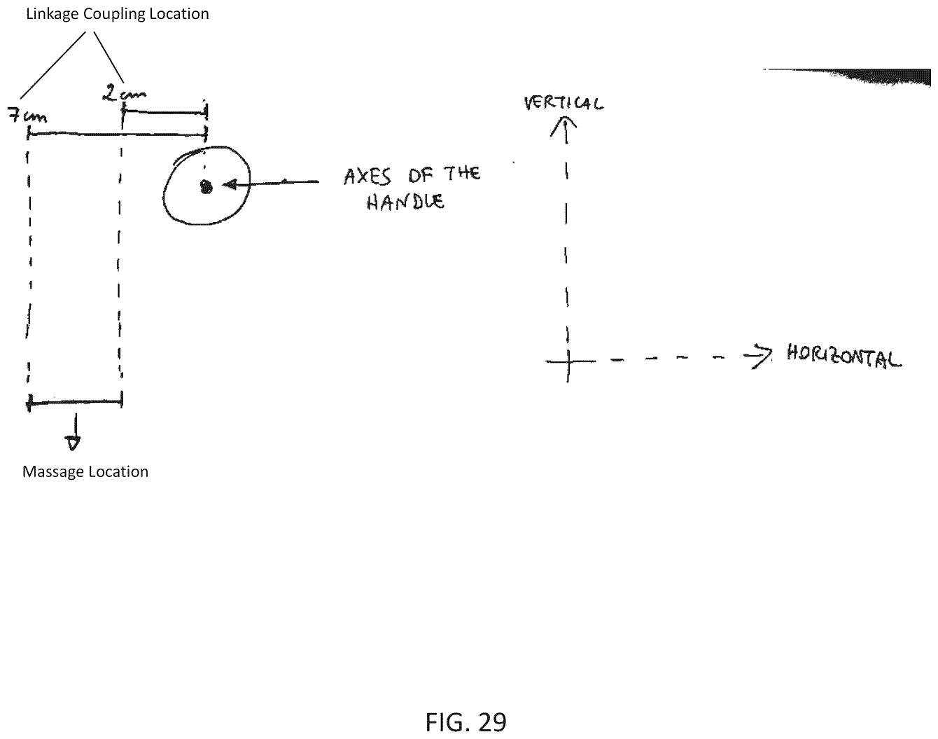

In some embodiments, a non-limiting example of geometrical criteria includes arrangement of a longitudinal center line axis of the handle such that when the massage head is in the starting position, the horizontal distance to the linkage coupling location is between a range of approximately 2 to 7 cm. In some embodiments, this range is configured to vary the moment arm for the torsional clamping force generation from the downward vertical applied translation force on the handle (see FIG. 29).

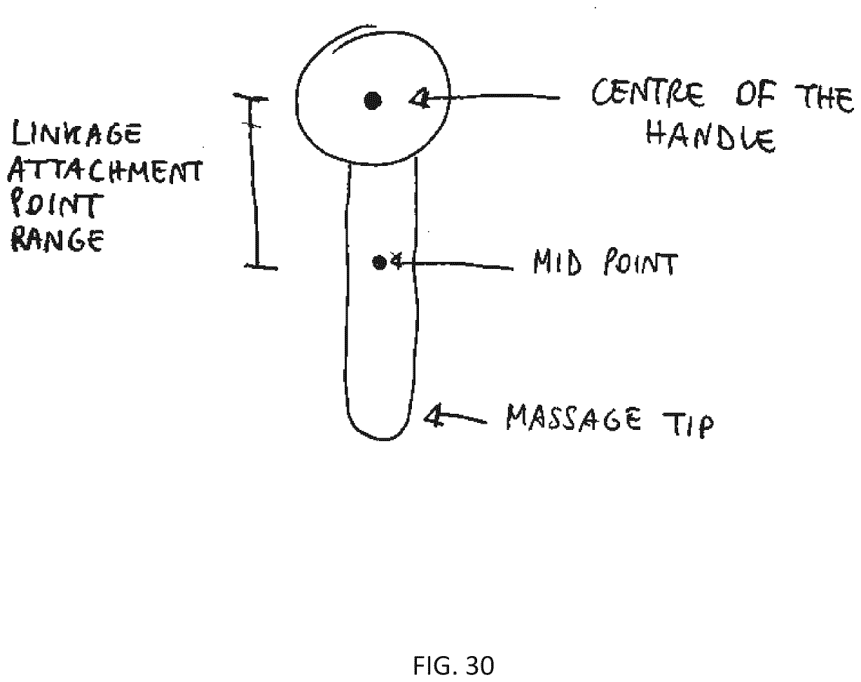

In some embodiments, a non-limiting example of geometrical criteria includes each linkage and/or linkage coupling located in a range between the handle and the massage head tip (see FIG. 30; also see FIG. 9 for an additional non-limiting example). In some embodiments, a non-limiting example of geometrical criteria includes the linkage coupling and the linkage substantially vertically aligned with the massage head tip when the device is held in the starting position (see FIG. 30). In some embodiments, the linkage coupling is offset from a center of the handle and/or the massage tip such that a triangle is formed from the 3 points.

In some embodiments, a non-limiting example of geometrical criteria includes the massage head tip oriented with a positive inward angle while in starting position, such that the two massage heads converge tangentially to each other as each frame is rotated by the articulation of the operator's (user's) wrist. In some embodiments, this movement is analogous to the tip of pliers as they are closed inwards. In some embodiments, an angle range between 5° and 50° has been shown empirically to achieve effective results.

In some embodiments, a non-limiting example of geometrical criteria includes BHS configured with a geometry such that when the operator's hand grips the handle, the BHS is directly in contact with the back of the operator's hand. In some embodiments, the rotation point is closer to the massage head tip than to the point of applied force, whether the force is applied to the handle alone or applied to the handle and BHS.

In some embodiments, a non-limiting example of geometrical criteria includes the distance between the handle axis and the massage head tip being as long as possible for mechanical advantage. However, empirical tests show that a distance range between 8 cm and 15 cm achieves the desired results according to some embodiments.

In some embodiments, a non-limiting example of geometrical criteria includes the (adjustable) linkage comprising a distance in a range of 10 cm to 25 cm between linkage couplings and/or hollow portions. In some embodiments, the linkage coupling includes a hollow portion configured to enable at least a portion of the linkage to pass therethrough.

In some embodiments, one or more frames comprise a geometric shape configured to enable a patient to lay and/or push the frame against a vertical (e.g., wall), horizontal (e.g., floor), and/or inclined surface (e.g. table) with a desired massage area to achieve a reciprocal self-massage function. In these modes of self-massage operation, articulation of the linkage is achieved by the slight self-driven movement of the patient's body. In some embodiments, respective frames are geometrically shaped such that during the self-massage, the system is able to articulate upon specified degrees of freedom mimicking handheld operations. In some embodiments, one or more frames include a stationary coupling configured to couple the frame to a surface mount on a surface allowing the aforementioned patient self-massage mode of operation. In some embodiments, the surface mount is configured to securely and/or removably attach to a surface.

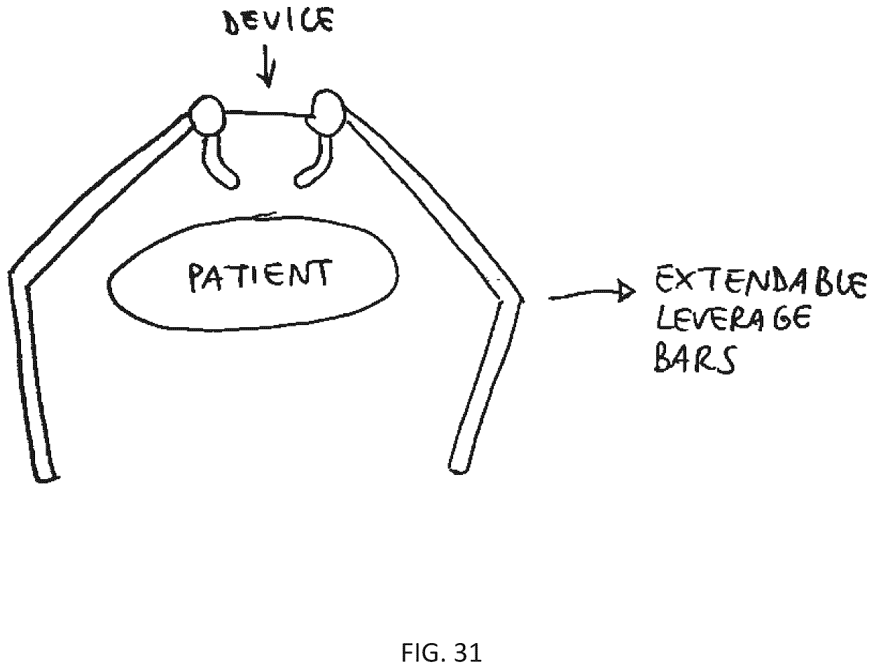

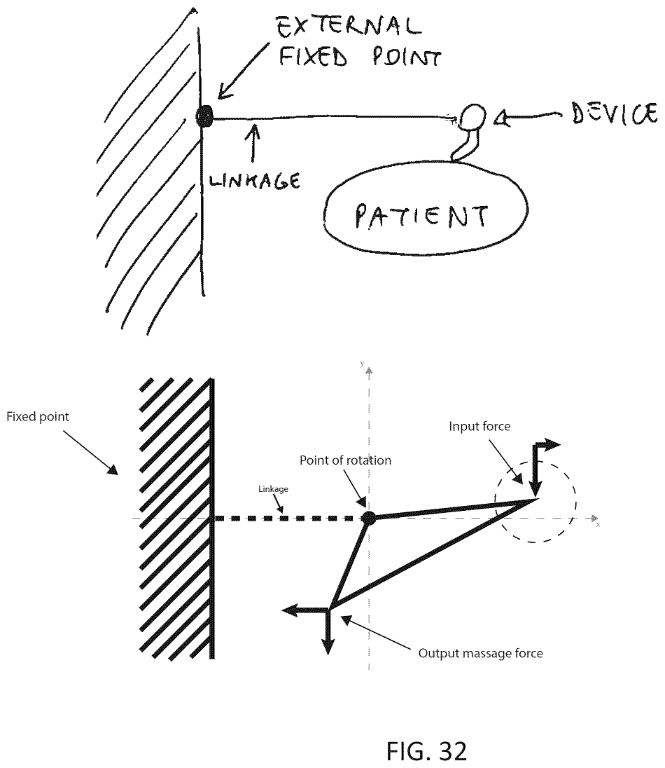

Referring now to FIG. 31, in some embodiments, one or more frames include one or more lever mounts configured to couple to one or more lever arms. In some embodiments, the one or more lever arms are configured to enable the patient to control articulation at the frame in a similar manner a user (e.g., chiropractor) would manipulate one or more frames by hand. In some embodiments, a kit includes one or more of one or more frames, one or more linkages, one or more BHSs, one or more base mounts, one or more racks, one or more mounts, and/or one or more lever arms. In some embodiments, the kit includes one or more configurations shown in any figure and/or described herein according to some embodiments. FIG. 31 illustrates a system kit according to some embodiments. In some embodiments, the system is configured to enable one or more linkages to couple to a surface of an external fixed point while enabling manipulation of a frame as shown in FIG. 32.

In some embodiments, a handle, rack, mount, linkage coupling, linkage, and/or BHS is removably attached to the frame. In some embodiments, the frame comprises one or more massage heads (e.g., see FIGS. 6, 8, 9, 11, 16, 18, 19, 20, 21 22, 23, 24, 26, 31, 32, 38, 39, 42 and/or 44). In some embodiments, one or more portions of the frame are configured to be used as a massage head. In some embodiments, the BHS is configured to be used as a massage head. In some embodiments, a least a portion of the linkage coupling is configured to be used as a massage head. In some embodiments, a handle is configured to be used as a massage head. In some embodiments, the frame includes one or more massage heads at one or more locations with one or more various relative radii (e.g., spherical surfaces) each configured to apply a different pressure (i.e., P=F/A) to a surface (e.g., patient's muscles). In some embodiments, one or more massage heads include a textured surface, while one or more massage heads include a smooth surface.

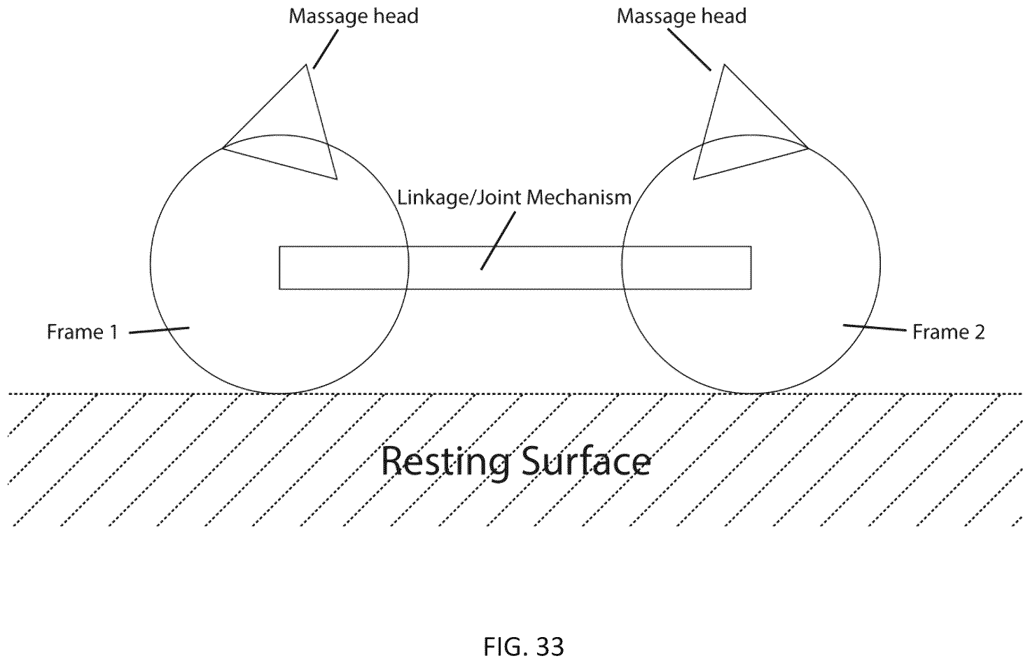

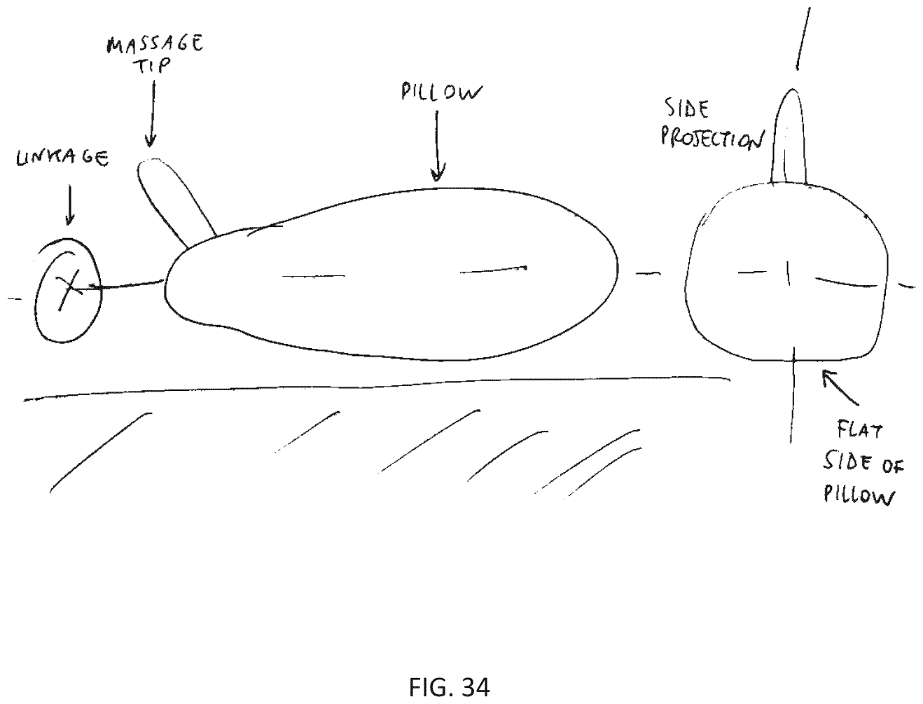

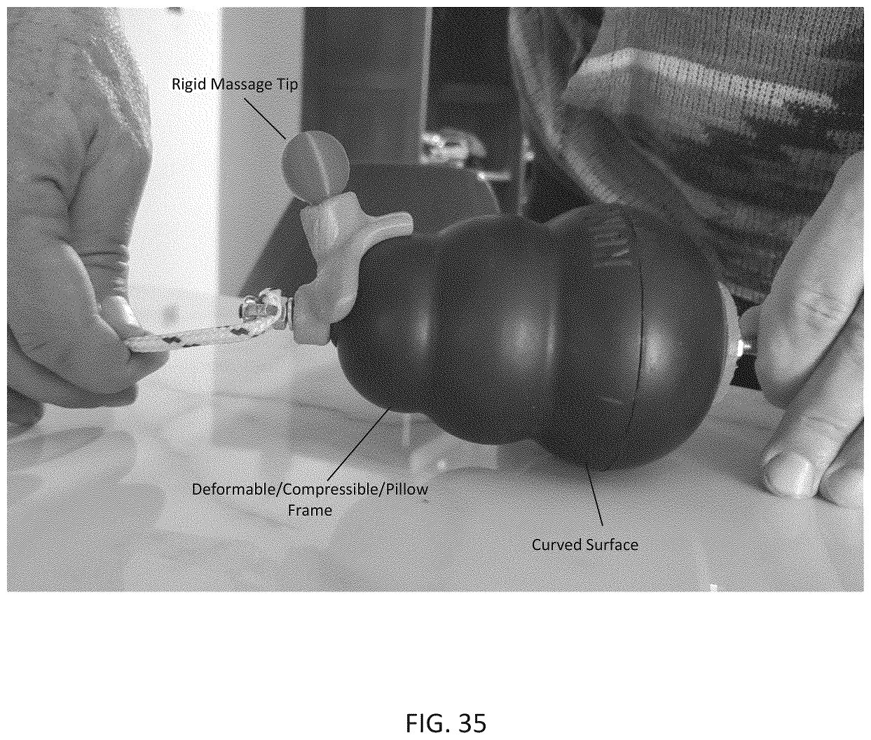

In some embodiments, the frames include one or more compressible and/or deformable members (e.g., rubber pneumatic pillows; see FIGS. 34 and 35) configured to be positioned on any surface with the patient lying on or pressing against the device. In some embodiments, the compressible members are configured to removably couple to a compressible member coupling on the frame. In some embodiments, the compressible member is configured to apply force by using an articulation of the body to generate a reciprocal articulation of the device (as illustrated in FIG. 33). In some embodiments, the input force (analogous to the operator's hand applied force to the handles and/or BHS in the handheld configurations) is the resultant reaction force from the resting surface to the compressible member at the point, line, and/or area of contact. In some embodiments, one or more (e.g., all) previously specified geometrical parameters described are applicable to the compressible member by replacing the applied force at the handle with the point of application of input force, thereby achieving a balance between vertical and torsional output force applied to the patient as previously mentioned. In some embodiments, this articulation is achieved by a shape and/or an angle of curvature of a compressible member bottom surface (e.g., in axes defining a plane parallel to the surface that the device is resting on).

In some embodiments, the compressible members (e.g., spheroidal support members) include at least one flat side that is at least partially flattened and/or configured to naturally roll to and/or rest on the flat side when laying on a flat surface. In some embodiments, the flat side is located on a surface distal from a massage head (e.g., opposite side, perpendicular, etc.). In some embodiments, the frame comprises one or more compressible members and/or compressible member shapes fixed between two rigid structures. In some embodiments, one or more rigid support members comprise a linkage coupling. In some embodiments, one or more rigid support members include and/or are a massage head (see FIG. 35). In some embodiments, the frame includes a center of mass such that its equilibrium resting position under the influence of gravity on a flat and/or resting surface is with the linkage principal axis in an orientation parallel to the flat and/or resting surface.

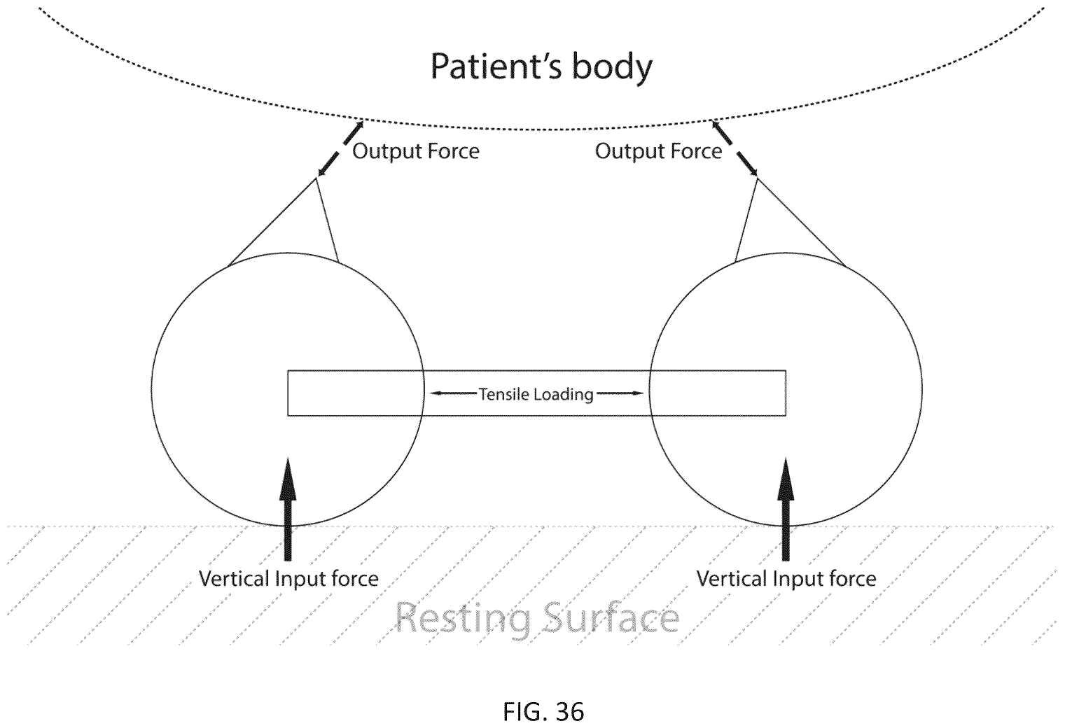

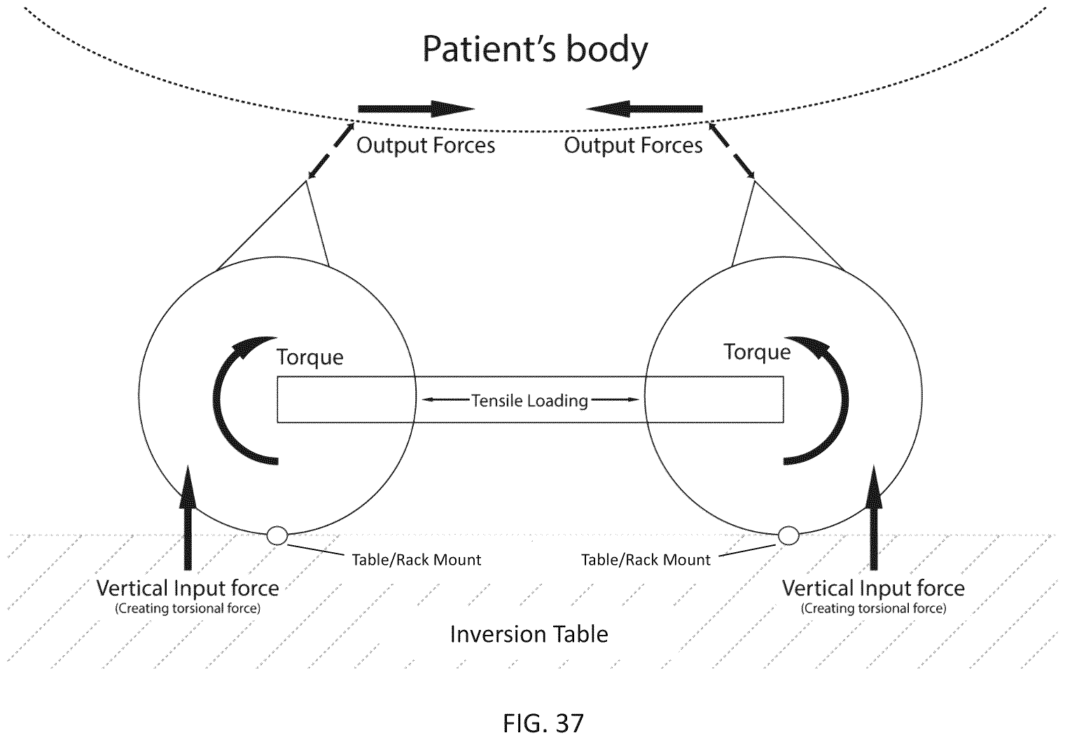

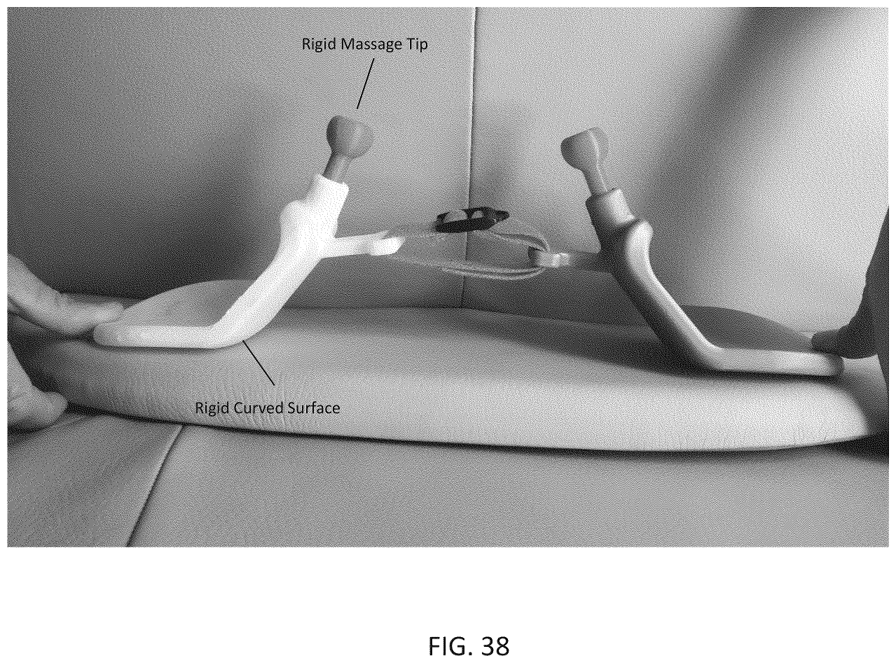

In some embodiments, as shown in FIG. 36, the frame includes a nonlinear and/or curved surface configured to achieve the desired movement and balance of output forces when applied to the patient in a similar manner as some embodiments described herein. In some embodiments, as shown in FIG. 37, vertical translational input loading deriving from the patient's body mechanical pressure and reaction force from the resting surface creates both a reciprocal vertical force and reciprocal torsional inward clamping force output to the patient. FIG. 38 shows a non-linear frame surface with massage heads according to some embodiments.

In some embodiments, the linkage is not adjustable and/or deformable. In some embodiments, one or more linkages include one or more massage head mounts configured to couple to massage heads. In some embodiments, the one or more massage head mounts are positioned at discrete positions along the principal axis. In some embodiments, the one or more massage head mounts are movable along the linkage. In some embodiments, distance between the respective massage heads on the respective frames are configured to be adjusted by means of selecting a discrete mounting head of a plurality of mounting heads, and/or moving a desired massage head to a new position and resulting spacing.

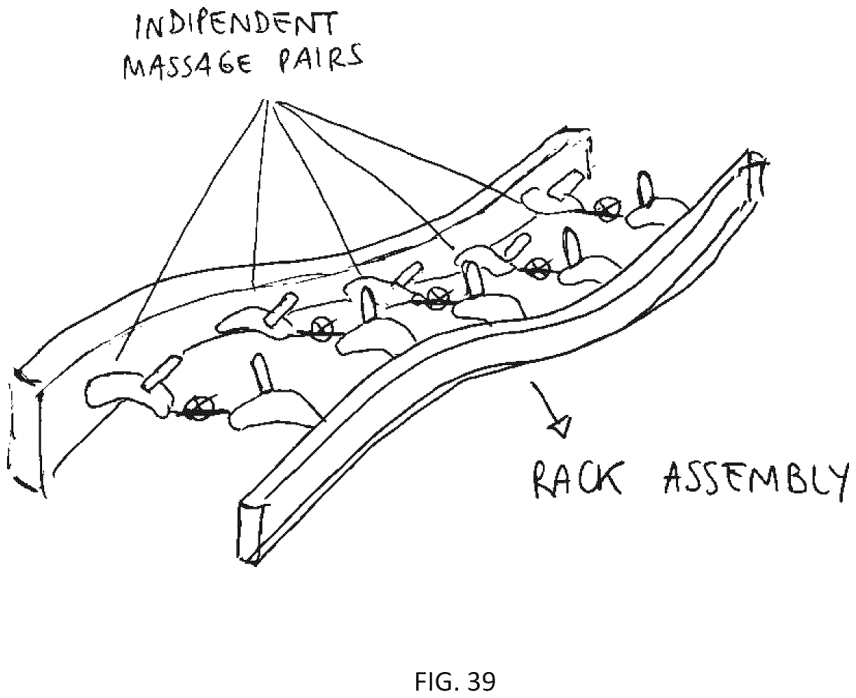

In some embodiments, the system (and/or kit) includes one or more frame racks each configured to couple to a plurality of frames (see FIG. 39). In some embodiments, the one or more racks are configured to enable a patient to lie on or press against the one or more racks and receive pressure from multiple pairs of bilateral massage points from the plurality of frames. In some embodiments, a non-limiting example of a method of use would be a patient laying on top of the rack with multiple device pairs approximately aligning to multiple vertebral disk locations along the spine. In some embodiments, one or more racks include one or more adjustable mounts and/or one or more mount locations configured to couple to each of the one or more frames. As with previous self-massaging descriptions, the massage is facilitated by the slight articulation of the patient's body. In some embodiments, the one or more arms are configured to couple to the one or more racks, where movement of an arm results in a movement of the rack and/or plurality of frames.

In some embodiments, the system includes an (inversion) table and/or one or more table and/or rack mounts (see FIG. 37). In some embodiments, the one or more table mounts are each configured to couple to one or more frames and/or one or more frame racks. In some embodiments, a method includes the patient lying on the system (e.g., secured to a fixed resting surface) as described herein according to some embodiments. In some embodiments, the patient achieves the desired bilateral focal point massage function while inverting either statically or dynamically on the (inversion) table. In some embodiments, one or more frames are configured to be fixed on a dynamic surface such as the curved rack assembly as illustrated in FIG. 39.

In some embodiments, one or more massage heads include one or more tip couplings configured to couple to one or more massage tips. In some embodiments, the one or more massage tips (and/or a kit) include massage tips of various sizes and shapes. In some embodiments, the system is configured to enable different tips to be secured to different frames (e.g., when the frames are joined by a linkage). In some embodiments, the different tips enable different applied pressures by each (joined) frame. In some embodiments, the system is configured to be used with two different specific massage heads to achieve different massage objectives on the two respective sides of the patient.

In some embodiments, a method of use includes a large surface area massage head used on one of two frames in a mode to achieve a stable “anchoring” effect with limited massage articulation while the alternative frame operates with a smaller diameter massage head to articulate and massage a specified area with a higher level of pressure point intensity. In some embodiments, massage head and massage head coupling (and/or any coupler described herein) includes any conventional male/female coupler. In some embodiments, massage head and massage head coupling (and/or any coupler described herein) includes a propriety coupler.

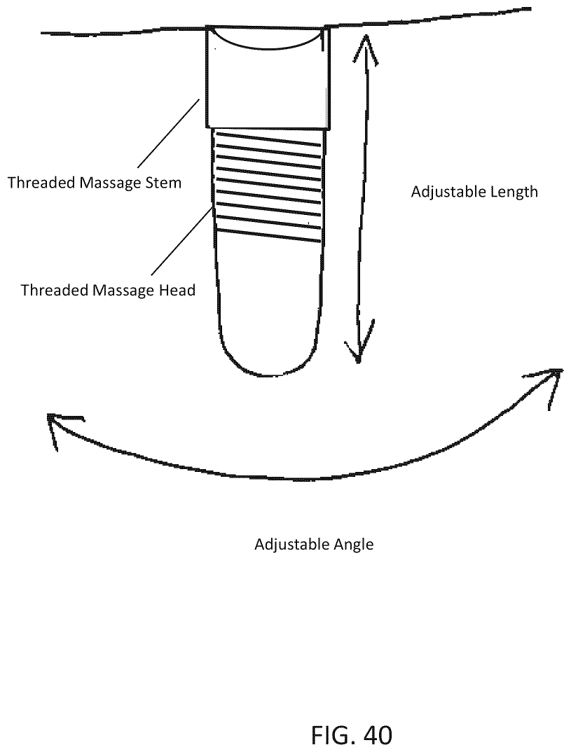

In some embodiments, one or more massage heads include a massage stem. In some embodiments, the massage stem includes an adjustable massage stem configured to telescope, rotate, and/or articulate to a new angle (see FIG. 40) about one or more shafts and/or stem joints.

In some embodiments, the one or more massage heads are configured to move relative to the frame. In some embodiments, the system includes a controller configured to control a motion of one or more massage heads. In some embodiments, the frame comprises the controller and/or one or more computers. In some embodiments, the system includes one or more computers comprising one or more processors and one or more non-transitory computer readable media, the non-transitory computer readable media comprising instructions stored thereon that when executed cause the one or more computers to implement one or more steps.

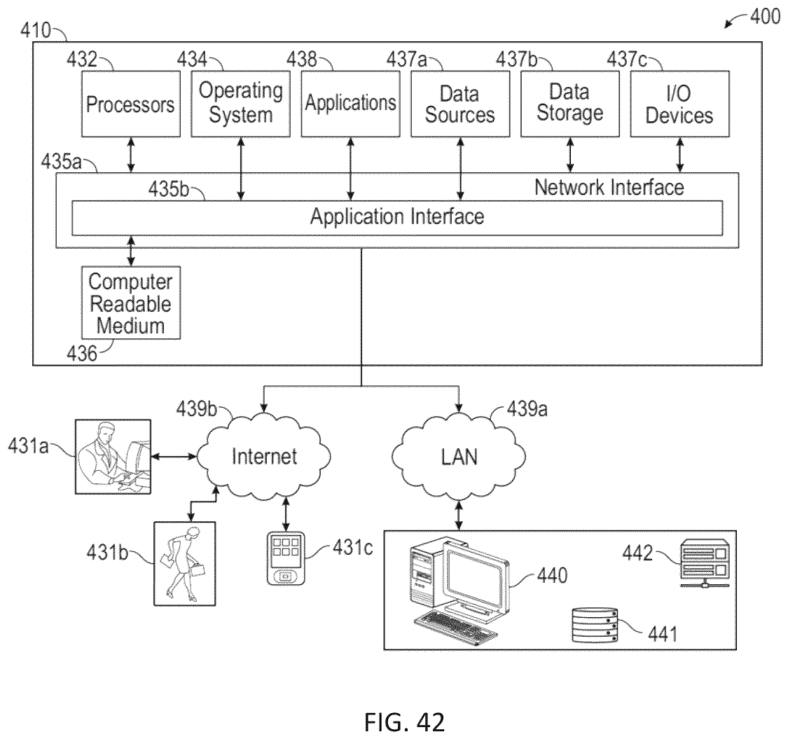

In some embodiments, a step includes instructions for the controller to move the one or more massage heads (e.g., vibrate, reciprocate, rotate, etc.) in a programmed manner. In some embodiments, a step includes instructions for a frame computer and/or controller to connect to one or more computers in a manner further described with reference to FIG. 42.

In some embodiments, a step includes implementing, by the one or more processors, a movement program. In some embodiments, the movement program includes steps to implement a head vibration. In some embodiments, the head vibration includes variable frequencies and/or pattern sequences of vibration. In some embodiments, the movement program includes a head reciprocation. In some embodiments, the head reciprocation includes mechanically reciprocating massage head implementation with variable frequencies, intensities and/or patterns.

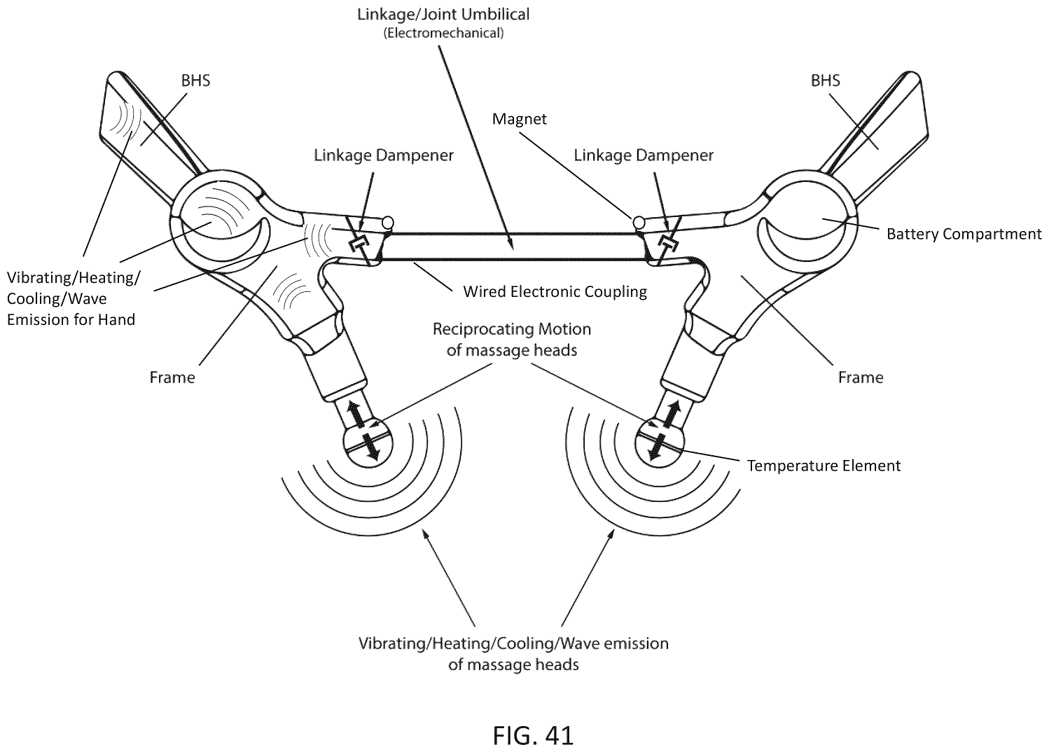

In some embodiments, the frame includes one or more dampeners (e.g., mechanical dampener). In some embodiments, the dampener is configured to couple to a linkage joint and/or linkage (see FIG. 41) and/or dampen motion along the principal axis. In some embodiments, a dampener is configured to dampen motion along an axis parallel to the axis of the massage head.

In some embodiments, the system includes one or more sensors configured to electronically couple to the one or more computers (any reference to a computer is also a reference to a controller and/or computer configured to control as used herein). In some embodiments, one or more sensors include a force sensor. In some embodiments, a force sensor includes a mechanical force sensor. In some embodiments, a mechanical force sensor includes one or more spring elements coupled between a massage head and an analog display. In some embodiments, a mechanical force sensor is configured to display an indication of translation between the massage head and the one or more springs. In some embodiments, the indication includes a quantitative value (e.g., number scale). In some embodiments, the indication includes a qualitative value (e.g., a color scale). In some embodiments, one or more sensors includes an electrical sensor. In some embodiments, the one or more sensors are configured to transmit an electrical signal representative of an applied force to one or more computers. In some embodiments, a program step includes instructions to display, by the one or more processors, the applied force on one or more graphical user interfaces (GUIs). In some embodiments, the one or more computers are configured to alert (e.g., visually, audibly, physically, etc.) a user if one or more sensor parameters are exceeded.

In some embodiments, the system includes one or more temperature elements (e.g., electronic circuits, Peltier (thermoelectric) chip, etc.). In some embodiments, one or more temperature elements are configured to heat and/or cool at least a portion of a massage head. In some embodiments, a program step includes instructions to set, apply, and/or maintain a massage head (tip) temperature. In some embodiments, a frame comprises a plurality of massage heads as previously described. In some embodiments, a method of use includes pre-cooling a massage head and/or massage tip with an external cooling source, and/or warming a massage head and/or massage tip with an external heating source.

In some embodiments, one or more massage heads are configured to emit a wave. In some embodiments, one or more massage heads are configured to emit an ultrasound wave. In some embodiments, non-limiting examples of a waves include light waves (e.g., infrared, visible, ultraviolet, etc.), electromagnetic waves (e.g., electrical signals), sound waves (e.g., ultrasound waves), and mechanical waves (e.g., vibration frequencies). In some embodiments, one or more of the BHS, the bridge, and the handle of the massage tool are configured to emit a wave, such that the hands of the operator also receive a therapeutic benefit. In some embodiments, any combination of vibrating, reciprocating, heating, cooling, and wave emitting function are integrated into one or more frames (e.g., a single frame: see FIG. 41).

In some embodiments, one or more computers coupled and/or integral to one or more frames are configured to electronically couple to each other. In some embodiments, the electronic coupling is one or more of wired and wireless. In some embodiments, the linkage includes a wired electronic coupling. In some embodiments, one or more frames include a near field communication device configured to electronically couple with another frame and/or computer. In some embodiments, a program step includes coordinating movement between two or more massage heads. In some embodiments, the two or more massage heads are located on two or more frames, respectively. In some embodiments, a program step includes a phased coordination of multiple reciprocating massage heads.

In some embodiments, one or more frames are configured to house one or more (rechargeable) batteries. In some embodiments, one or more frames comprise one or more magnets. In some embodiments, the one or more magnets are positioned in each respective frame to cause an attraction between the two or more frames.

In some embodiments, the system (including a kit) includes two virtually identical opposing frames, each with one or more operative massage heads, and each frame connected to each other by a linkage, such that there are both free and fixed motional degrees of freedom of each frame. In some embodiments, the linkage includes a fixed degree of freedom in the direction of outward extension tensile loading and translation separating the two frames along a principal axis of a linkage connecting to at least one linkage coupling on each respective frame. In some embodiments, one or more massage heads are inclined inward toward a respective massage head (or heads) on the opposing frame. In some embodiments, the linkage is configured to be adjustable allowing a change in the spatial distance between the two respective frames. In some embodiments, the linkage couplings are located at an internal position on the frame along the principal axis of the linkage relative to the location of external input drive force(s) application to the device.

FIG. 42 illustrates a computer system 110 enabling or comprising the systems and methods in accordance with some embodiments of the system. In some embodiments, the computer system 110 is configured to operate and/or process computer-executable code of one or more software modules of the aforementioned system and method. Further, in some embodiments, the computer system 110 is configured to operate and/or display information within one or more graphical user interfaces (e.g., HMIs) integrated with or coupled to the system.

In some embodiments, the computer system 110 comprises one or more processors 132. In some embodiments, at least one processor 132 resides in, or is coupled to, one or more servers. In some embodiments, the computer system 110 includes a network interface 135a and an application interface 135b coupled to the least one processor 132 capable of processing at least one operating system 134. Further, in some embodiments, the interfaces 135a, 135b coupled to at least one processor 132 are configured to process one or more of the software modules (e.g., such as enterprise applications 138). In some embodiments, the software application modules 138 includes server-based software. In some embodiments, the software application modules 138 are configured to host at least one user account and/or at least one client account, and/or configured to operate to transfer data between one or more of these accounts using one or more processors 132.

With the above embodiments in mind, it is understood that the system is configured to implements various computer-implemented program steps involving data stored one or more non-transitory computer media according to some embodiments. In some embodiments, the above-described databases and models described throughout this disclosure are configured to store analytical models and other data on non-transitory computer-readable storage media within the computer system 110 and on computer-readable storage media coupled to the computer system 110 according to some embodiments. In addition, in some embodiments, the above-described applications of the system are stored on computer-readable storage media within the computer system 110 and on computer-readable storage media coupled to the computer system 110. In some embodiments, these operations are those requiring physical manipulation of structures including electrons, electrical charges, transistors, amplifiers, receivers, transmitters, and/or any conventional computer hardware in order to transform an electrical input into a different output. In some embodiments, these structures include one or more of electrical, electromagnetic, magnetic, optical, and/or magneto-optical signals capable of being stored, transferred, combined, compared and otherwise manipulated. In some embodiments, the computer system 110 comprises at least one computer readable medium 136 coupled to at least one of at least one data source 137a, at least one data storage 137b, and/or at least one input/output 137c. In some embodiments, the computer system 110 is embodied as computer readable code on a computer readable medium 136. In some embodiments, the computer readable medium 136 includes any data storage that stores data, which is configured to thereafter be read by a computer (such as computer 140). In some embodiments, the non-transitory computer readable medium 136 includes any physical or material medium that is used to tangibly store the desired information, steps, and/or instructions and which is configured to be accessed by a computer 140 or processor 132. In some embodiments, the non-transitory computer readable medium 136 includes hard drives, network attached storage (NAS), read-only memory, random-access memory, FLASH based memory, CD-ROMs, CD-Rs, CD-RWs, DVDs, magnetic tapes, and/or other optical and non-optical data storage. In some embodiments, various other forms of computer-readable media 136 are configured to transmit or carry instructions to one or more remote computers 140 and/or at least one user 131, including a router, private or public network, or other transmission or channel, both wired and wireless. In some embodiments, the software application modules 138 are configured to send and receive data from a database (e.g., from a computer readable medium 136 including data sources 137a and data storage 137b that comprises a database), and data is configured to be received by the software application modules 138 from at least one other source. In some embodiments, at least one of the software application modules 138 are configured to be implemented by the computer system 110 to output data to at least one user 131 via at least one graphical user interface rendered on at least once digital display.

In some embodiments, the one or more non-transitory computer readable 136 media are distributed over a conventional computer network via the network interface 135a where some embodiments stored the non-transitory computer readable media are stored and executed in a distributed fashion. For example, in some embodiments, one or more components of the computer system 110 are configured to send and/or receive data through a local area network (“LAN”) 139a and/or an internet coupled network 139b (e.g., such as a wireless internet). In some embodiments, the networks 139a, 139b include one or more wide area networks (“WAN”), direct connections (e.g., through a universal serial bus port), or other forms of computer-readable media 136, and/or any combination thereof.

In some embodiments, components of the networks 139a, 139b include any number of personal computers 140 which include for example desktop computers, laptop computers, and/or any fixed, generally non-mobile internet appliances coupled through the LAN 139a. For example, some embodiments include one or more personal computers 140, databases 141, and/or servers 142 coupled through the LAN 139a that are configured for use by any type of user including an administrator. Some embodiments include one or more personal computers 140 coupled through network 139b. In some embodiments, one or more components of the computer system 110 are configured to send or receive data through an internet network (e.g., such as network 139b). For example, some embodiments include at least one user 131a, 131b, coupled wirelessly and accessing one or more software modules of the system including at least one enterprise application 138 via an input and output (“I/O”) 137c. In some embodiments, the computer system 110 is configured to enable at least one user 131a, 131b, to be coupled to access enterprise applications 138 via an I/O 137c through LAN 139a. In some embodiments, the user 131 includes a user 131a coupled to the computer system 110 using a desktop computer, and/or laptop computers, or any fixed, generally non-mobile internet appliances coupled through the internet 139b. In some embodiments, the user includes a mobile user 131b coupled to the computer system 110. In some embodiments, the user 131b connects using any mobile computing 131c to wireless coupled to the computer system 110, including, but not limited to, one or more personal digital assistants, at least one cellular phone, at least one mobile phone, at least one smart phone, at least one pager, at least one digital tablets, and/or at least one fixed or mobile internet appliances.

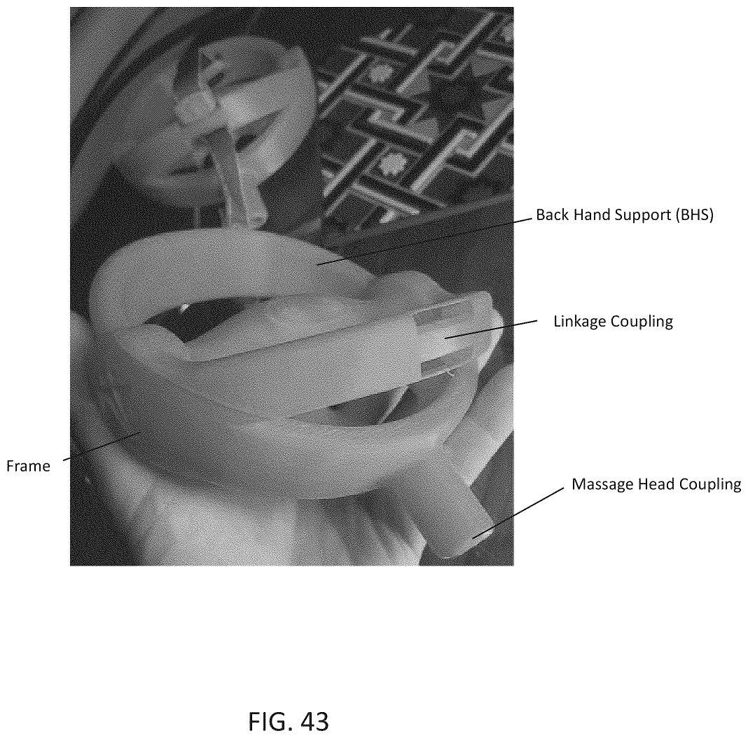

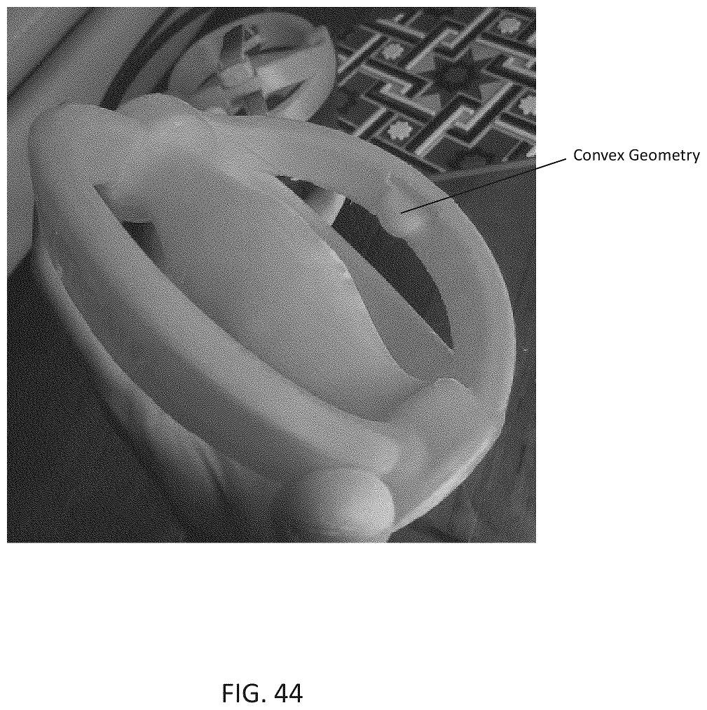

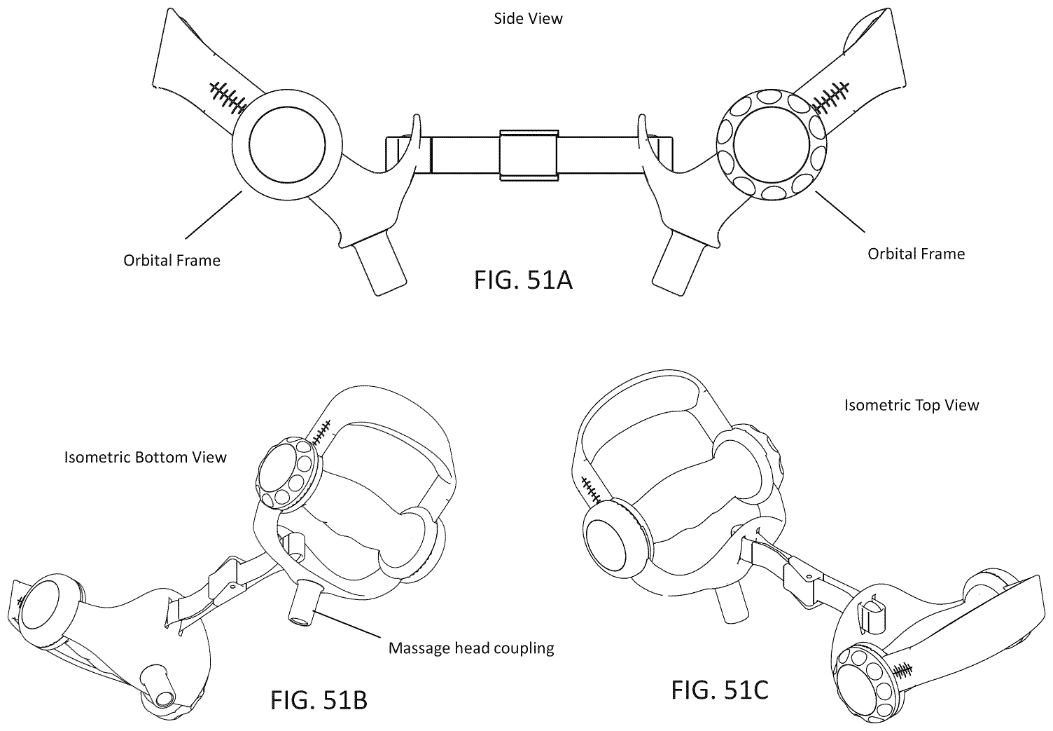

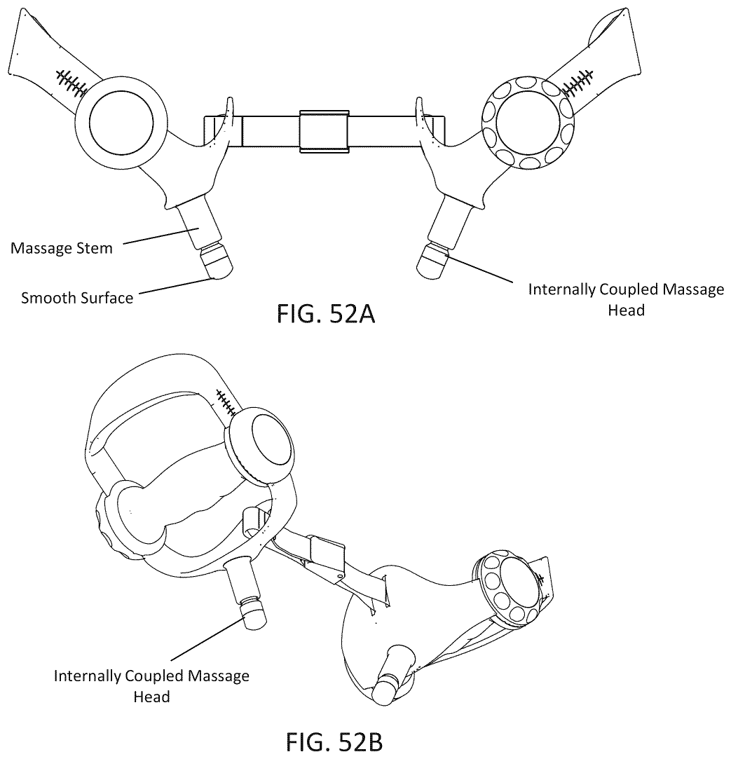

FIGS. 51A-51C show views of an adjustable orbital frame system according to some embodiments. In some embodiments, the orbital frame assembly is similar to the orbital frame shown in FIGS. 43-49, the difference being the adjustable components which are described here in detail. FIGS. 52A-52B depict internally coupled massage heads attached to orbital frames according to some embodiments. In some embodiments, at least a portion the massage head is configured to coupled to an internal portion of the massage stem. In some embodiments, the massage heads include a stem fastener. In some embodiments, the stem fastener (internal or external) includes one or more of a threaded portion, an interference portion, and a friction portion.

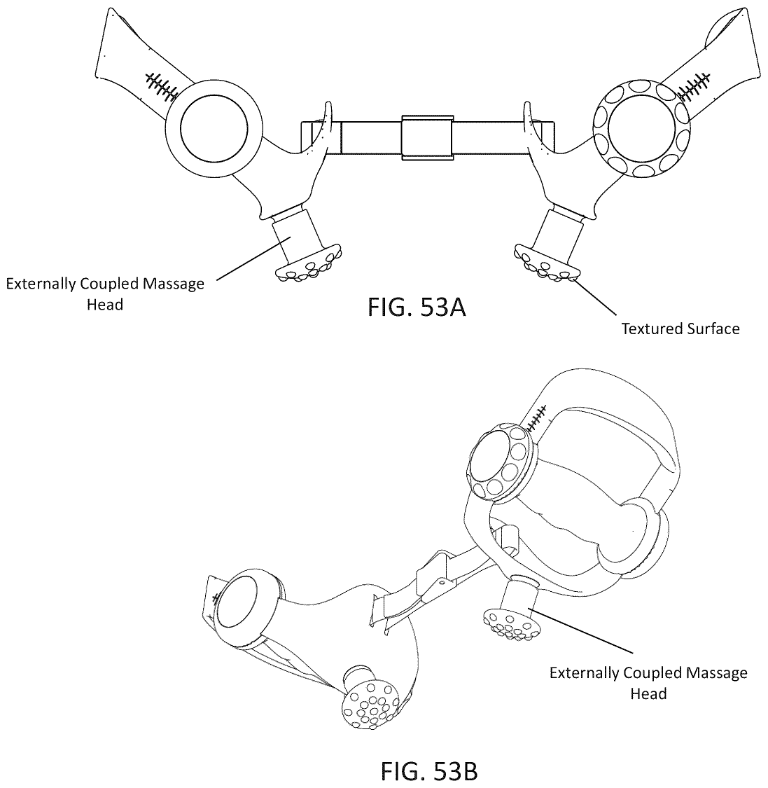

FIGS. 53A-53B illustrate externally coupled massage heads attached to orbital frames according to some embodiments. Advantageously, the exterior portion and the interior of the massage stem is configured to couple to one or more massage heads according to some embodiments. In some embodiments, the system includes massage heads configured to attach to one or more of the internal stem portion and the external stem portion.

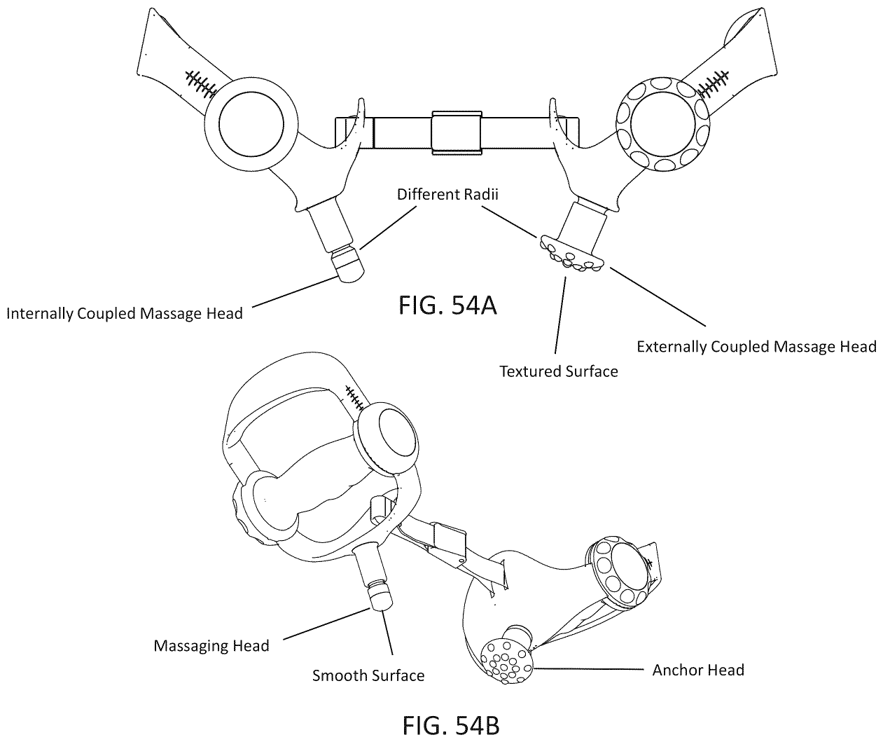

FIGS. 54A-54B illustrate different massage head attached to different orbital frames according to some embodiments. The externally coupled massage head shown in this non-limiting example according to some embodiments includes a textured surface and a greater radii than the internally coupled massage head. This allows for the implementation of a method where one massage tool is held in a fixed position using the massage head as an anchor while the other massage tool is manipulated about the rotation point according to some embodiments. In some embodiments, the larger radii massage head is used as an anchor due to the increased friction from the larger area.

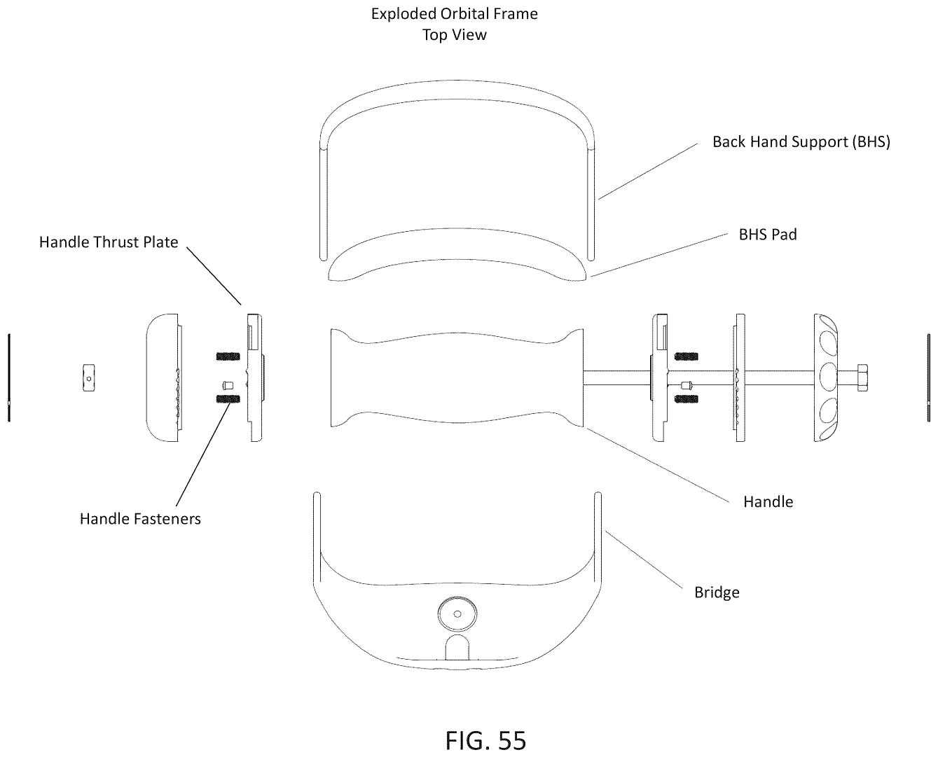

FIG. 55 shows and exploded orbital frame top view according to some embodiments. In some embodiments, the orbital frame includes one or more of a back hand support (BHS), a BHS pad, a handle, a bridge, handle thrust plates, and handle fasteners. In some embodiments, the handle fasteners are configured to secure each handle thrust plate to the handle to prevent rotation of the handle thrust plate. In some embodiments, the BHS and the bridge are configured to cooperate with the handle thrust plate as further described below.

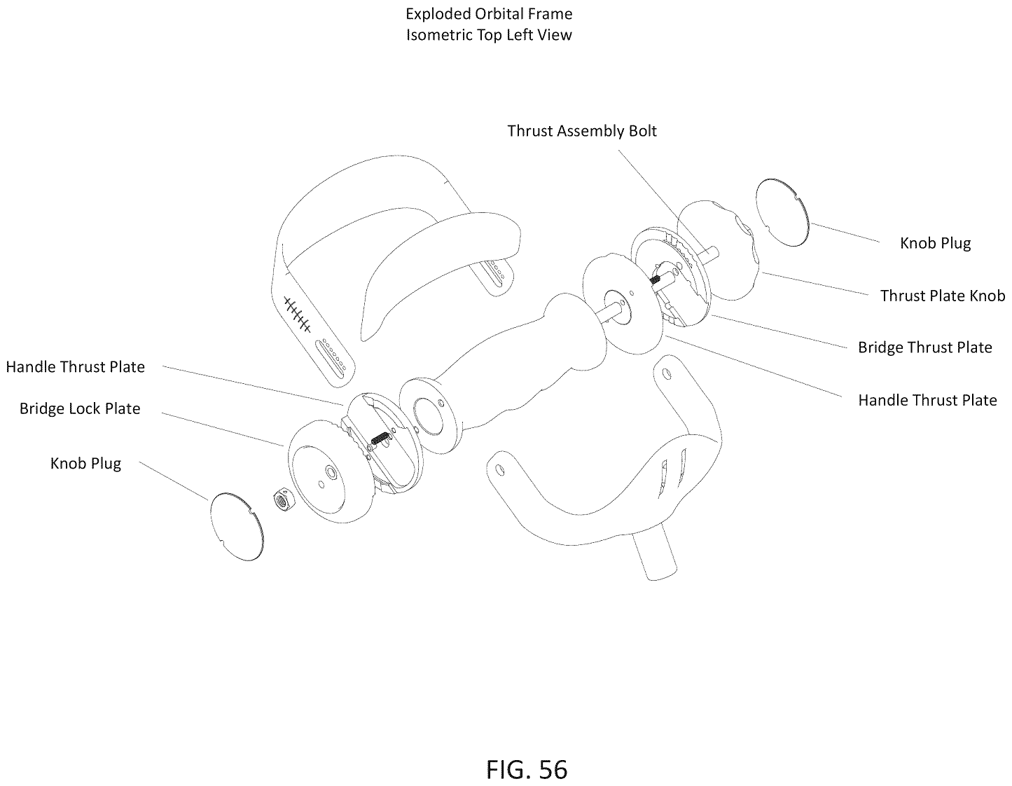

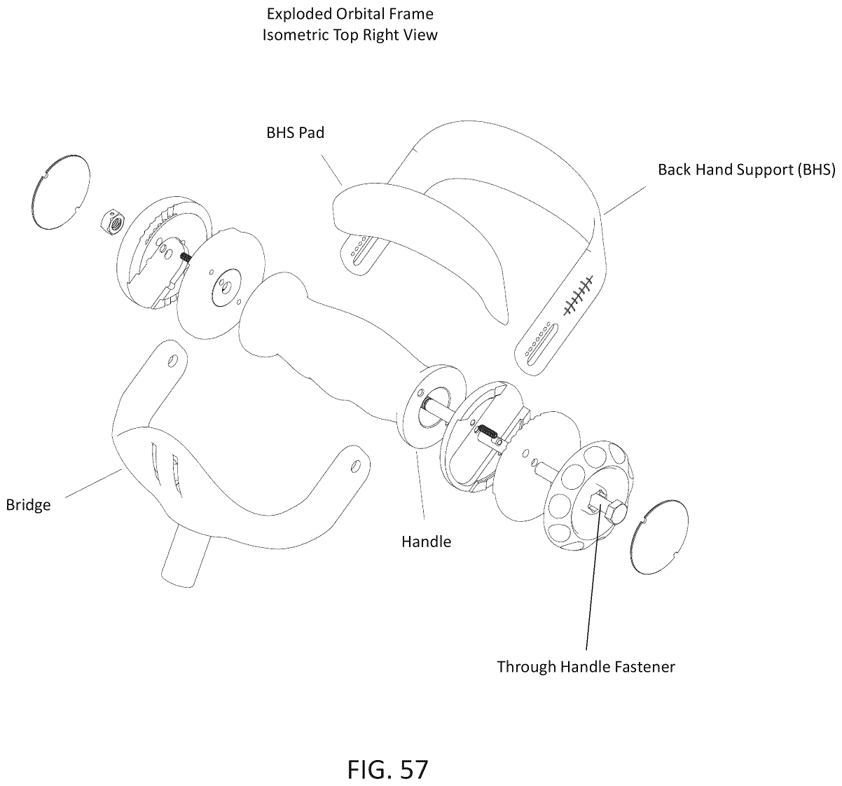

FIG. 56 shows an exploded orbital frame isometric top left view according to some embodiments. According to a method of assembly, the handle thrust plates are secured to the handle, where the bridge is inserted between the handle and the handle thrust plate. In some embodiments, the BHS is inserted within a BHS receiving portion of the handle thrust plate. In some embodiments, the bridge is positioned within a bridge receiving portion of the handle thrust plate, which results in each bridge arm overlapping each BHS arm once assembled. In some embodiments, the assembly includes a through fastener which in this non-limiting example includes a thrust assembly bolt. After the thrust assembly bolt is passed through all components and secured in place, the knob plugs are inserted as covers on either end. FIG. 57 depicts an exploded orbital frame isometric top right view according to some embodiments.

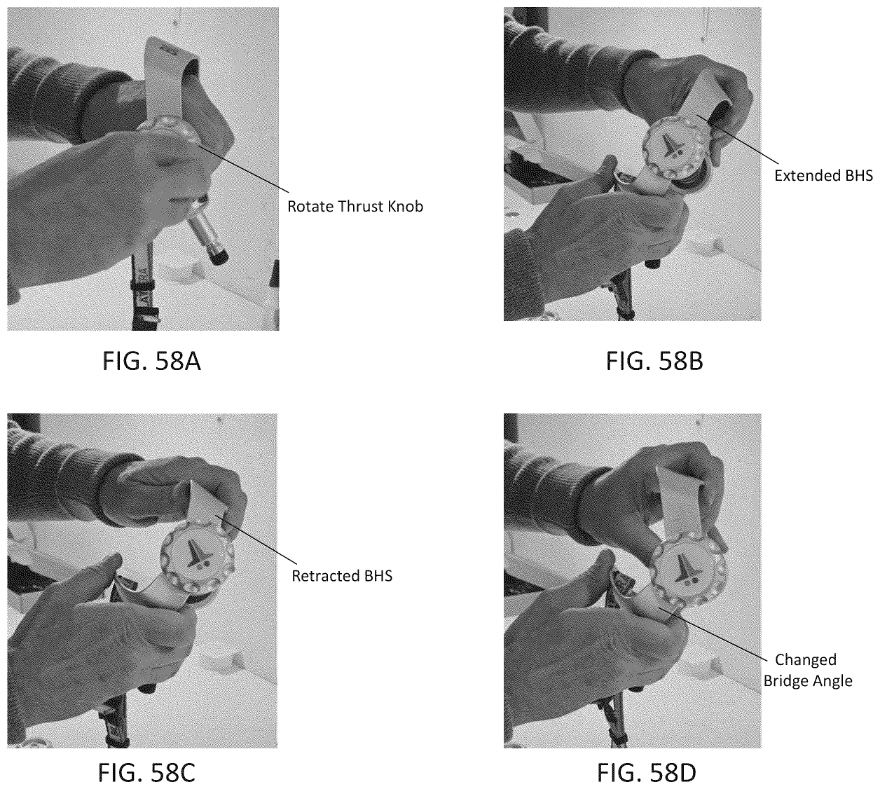

FIGS. 58A-58D illustrate and adjustment method for an orbital frame according to some embodiments. Some embodiments include a step to rotate the thrust knob to release engagement of the thrust knob against the bridge thrust plate as shown in FIG. 58A. FIG. 58B shows extending the BHS in a vertical direction, while FIG. 58C shows a retracted position where the BHS is pushed down according to some embodiments. FIG. 58D shows a step of adjusting the bridge angle by rotating the bridge about the handle axis, which changes a direction of the applied force of a massage head according to some embodiments.

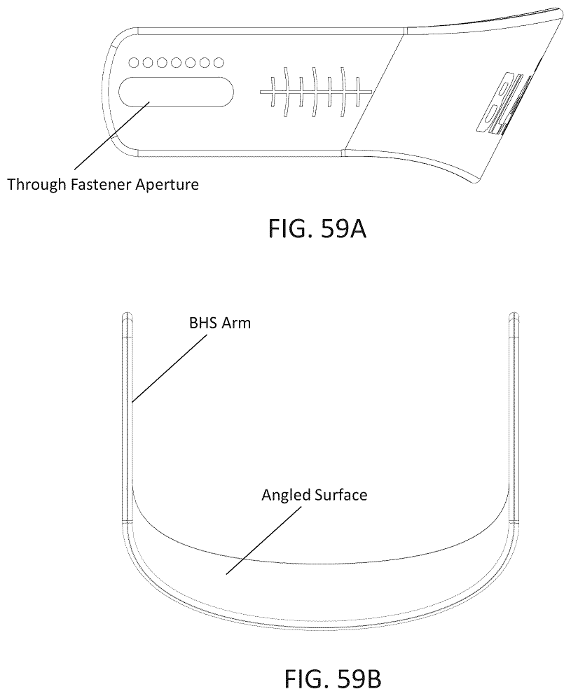

FIGS. 59A-59B depict a back hand support (BHS) portion of an orbital frame according to some embodiments. In some embodiments, the through handle aperture includes an elongated slot. In some embodiments, the elongated slot is configured to enable the BHS arm to translate vertically while coupled to the through fastener. In some embodiments, the BHS may include one or more recesses and/or protrusions configured to cause an audible click during adjustment.

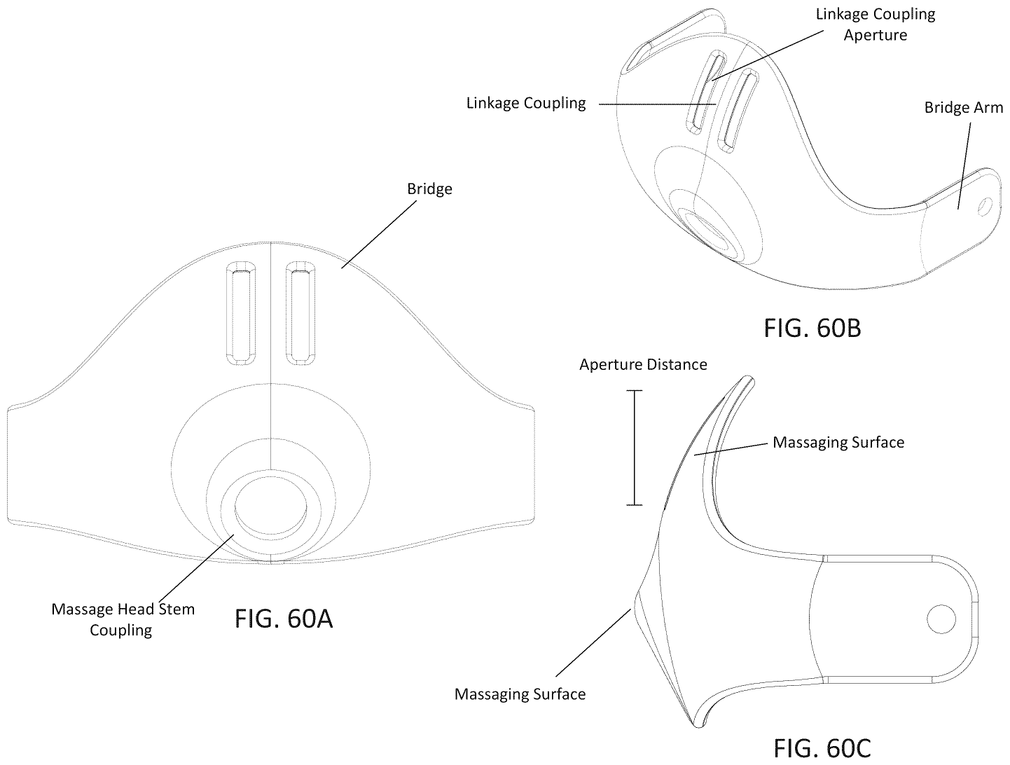

FIGS. 60A-60C illustrate a bridge portion of an orbital frame according to some embodiments. In some embodiments, the bridge includes a massage head stem coupling configured to couple to a massage head stem. In some embodiments, one or more portions of the bridge is configured to be used as a massaging surface, which may be useful in applications where less pressure is desired. In some embodiments, the bridge includes one or more linkage couplings, which in this non-limiting example includes one or more linkage apertures. In some embodiments, the one or more linkage apertures include an aperture distance that is larger than the linkage diameter, such that the linkage can slide along the linkage coupling. This may occur automatically when the angle of the bridge is changed, or may be the result of manual adjustment according to some embodiments.

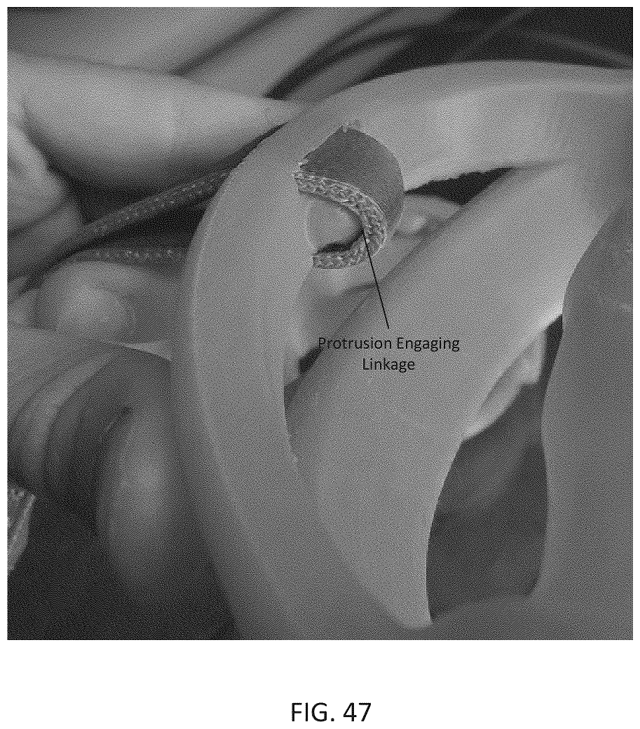

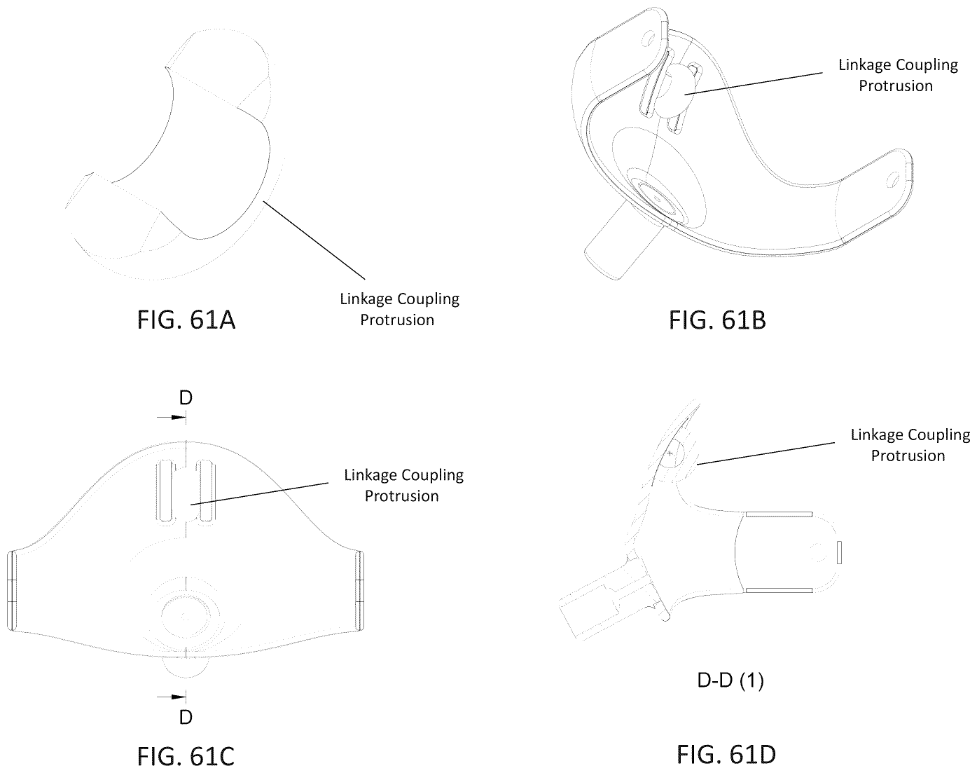

FIGS. 61A-61D show features of a linkage coupling protrusion according to some embodiments. In some embodiments, the linkage coupling includes a linkage coupling protrusion on the handle side of the bridge. In some embodiments, the linkage coupling is configured to apply force to an entire linkage surface (e.g., strap surface) when the strap surface changes angles (see FIGS. 47-49). In some embodiments, the linkage coupling protrusion includes a round profile.

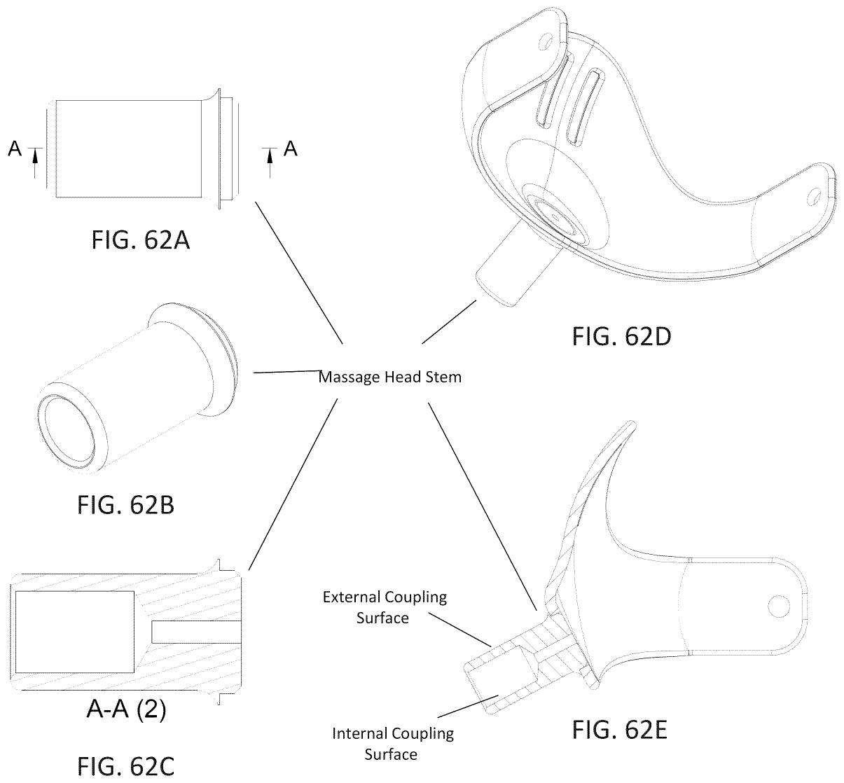

FIGS. 62A-62E show various features of a massage head stem according to some embodiments. As explained previously, the massage head stem is configured to couple to the bridge using one or more fastening techniques described herein, which in this non-limiting example includes an interference fastener. FIG. 62E shows details of both the internal and external coupling surfaces according to some embodiments.

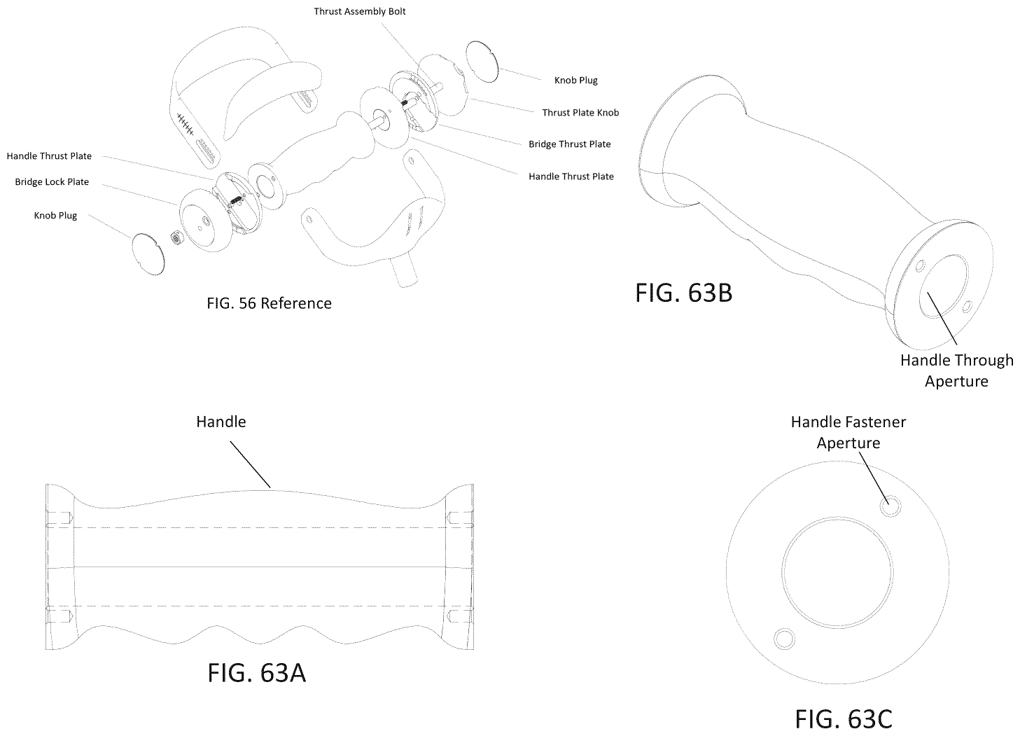

FIGS. 63A-63C depict views of a handle portion of an orbital frame according to some embodiments. In some embodiments, the handle includes a handle through aperture configured to enable the thrust assembly bolt to pass therethrough. In some embodiments, the handle fastener apertures are configured to secure the handle thrust plate to the handle as previously described.

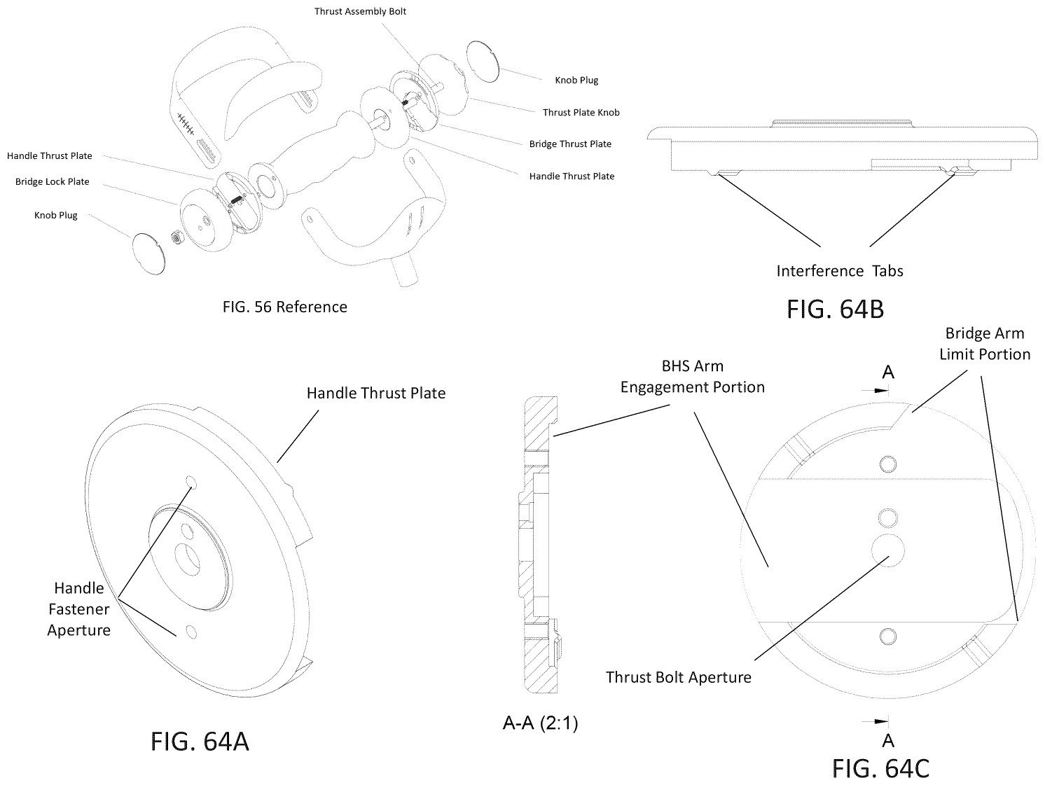

FIGS. 64A-64C show different views of a handle thrust plate on the right side of FIG. 56 according to some embodiments. Both handle thrust plates are similar, and this view shows the handle fastener apertures as well as the interference tabs configured to lock against the bridge thrust plate rotational locks. In some embodiments, the handle thrust plate includes a BHS arm engagement portion which includes a recessed slot in this non-limiting example. In some embodiments, the recessed slot is configured engage the side of the BHS while allowing for extension and retraction within the recessed slot. In some embodiments, the handle thrust plate includes a bridge arm limit portion. In some embodiments, the bridge arm limit portion includes a gap wider than the width of a bridge arm. In some embodiments, the bridge arm limit portion is configured to stop rotation of the bridge and/or bridge arm(s). In some embodiments, the gap is configured to enable a rotation of the bridge to up to 270 degrees. In some embodiments, the gap is configured to enable a rotation of the bridge between 0 and 90 degrees. In some embodiments, the gap is configured to enable a rotation of the bridge between 0 and 45 degrees, as well as any degree between.

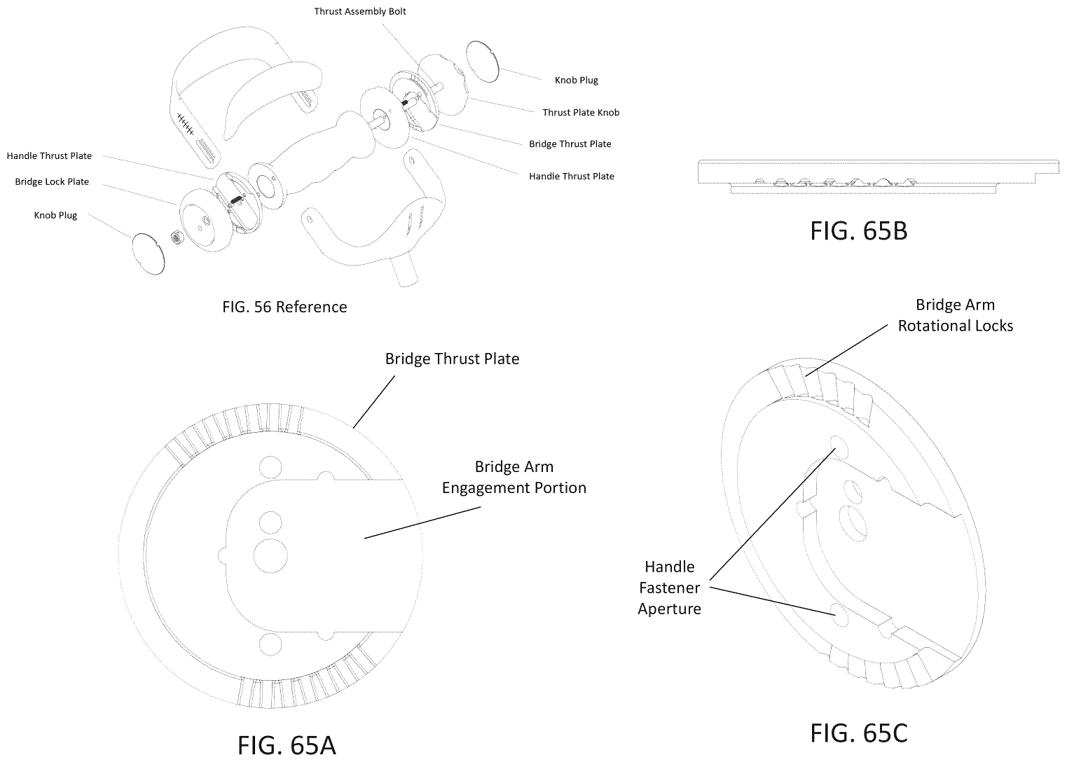

FIGS. 65A-65C illustrate a bridge thrust plate according to some embodiments. In some embodiments, while the handle thrust plate remains fixed, the bridge thrust plate is configured to move with the bridge and/or bridge arm during rotation. In some embodiments, the bridge thrust plate includes a bridge arm engagement portion. In some embodiments, the bridge thrust plate bridge arm engagement portion is configured to rotate with the bridge arm, where translation of the bridge arm is prevented by the thrust assembly bolt passing through both the bridge thrust plate and the bridge arm.

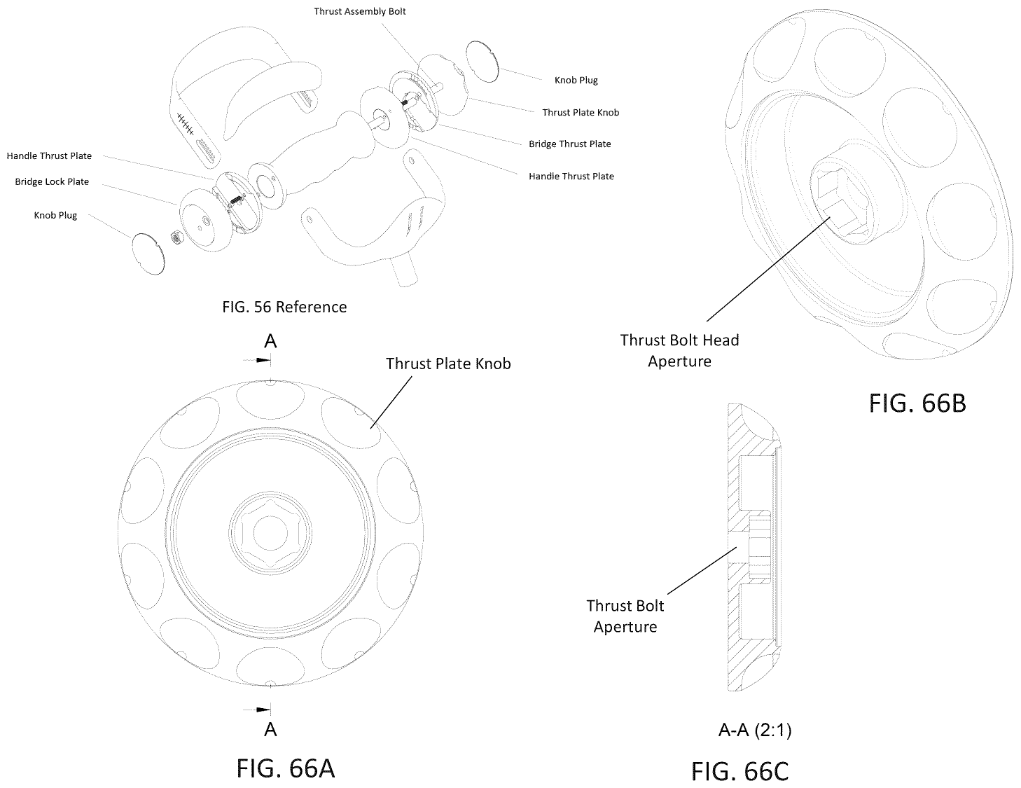

FIGS. 66A-66C illustrate a thrust plate knob according to some embodiments. As previously described, in some embodiments, rotation of the thrust plate knob is configured to result in an unthreading of the thrust assembly bolt allowing separation of the bridge thrust plate from the handle thrust plate. This is due to the thrust assembly bolt head interfering with the walls of the thrust bolt head aperture, where rotation of the thrust plate knob unthreads the other end of the thrust assembly bolt coupled to the bridge lock plate according to some embodiments.

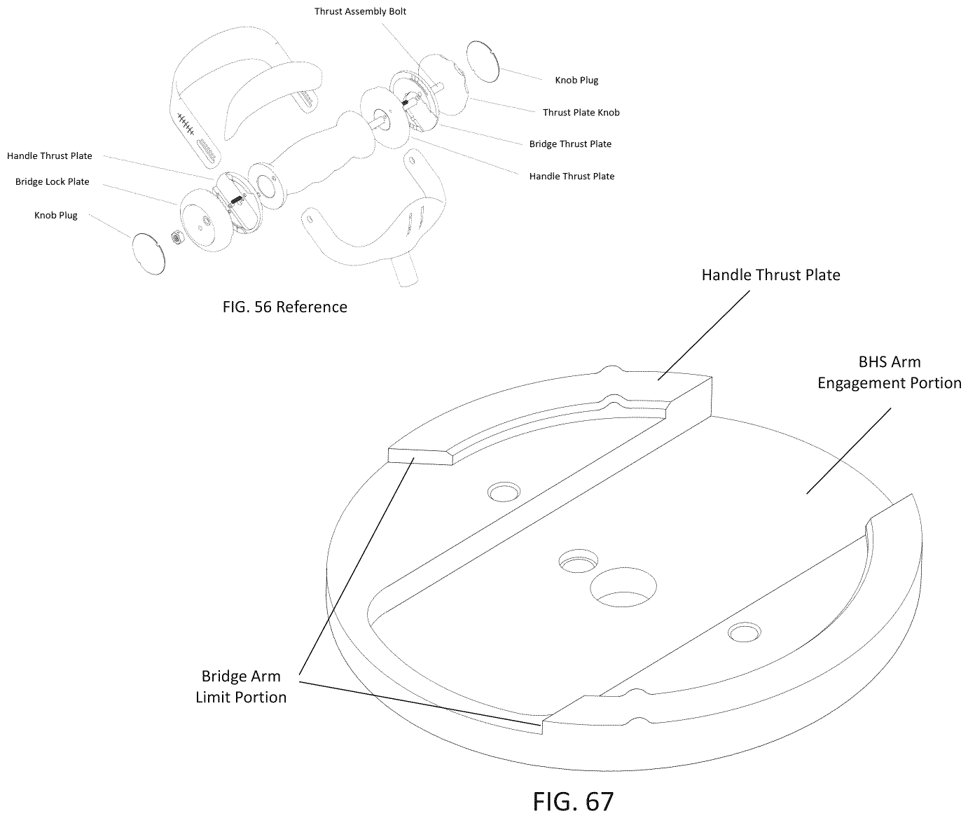

FIG. 67 depicts a second handle thrust plate according to some embodiments. As mentioned previously, the handle thrust plates on either side of FIG. 56 are the same according to some embodiments, however this figure is intended to highlight the left side. In some embodiments, details including raised portions of the bridge arm limit portion and/or recessed portions of the BHS arm engagement portion are emphasized in the figure.

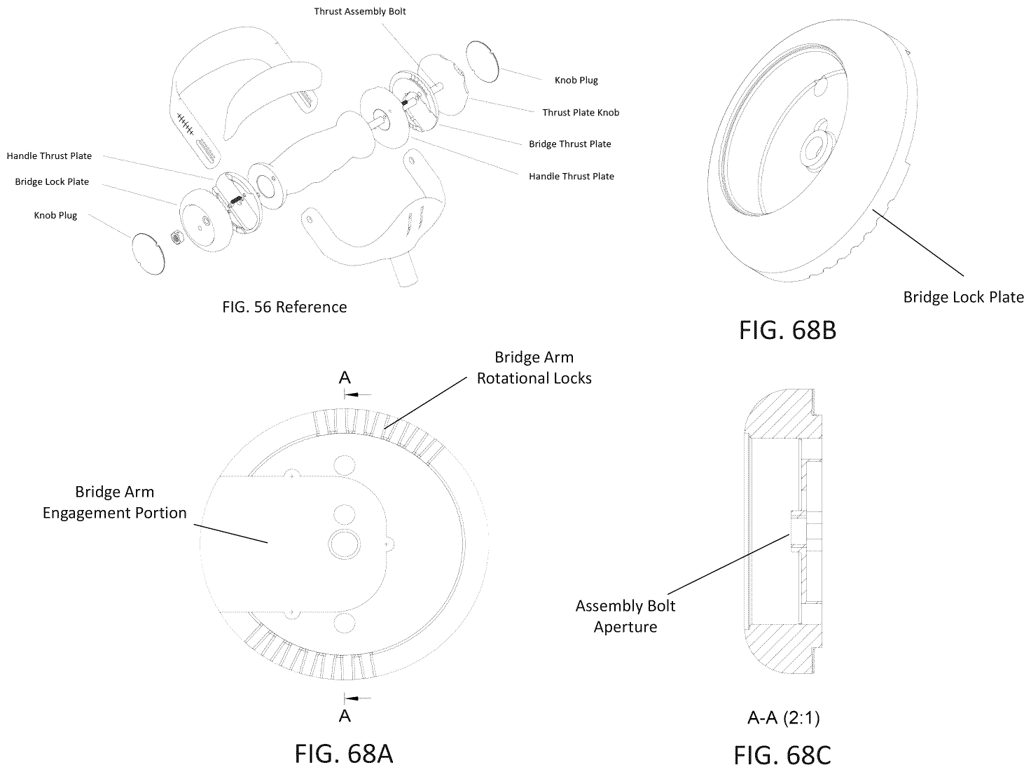

FIGS. 68A-68C show a bridge lock plate according to some embodiments. In some embodiments, the bridge lock plate is similar in construction to the bridge thrust plate and engages and disengages the handle thrust plate in a similar fashion. However, once the thrust plate knob is tightened the bridge lock plate is locked in position according to some embodiments.

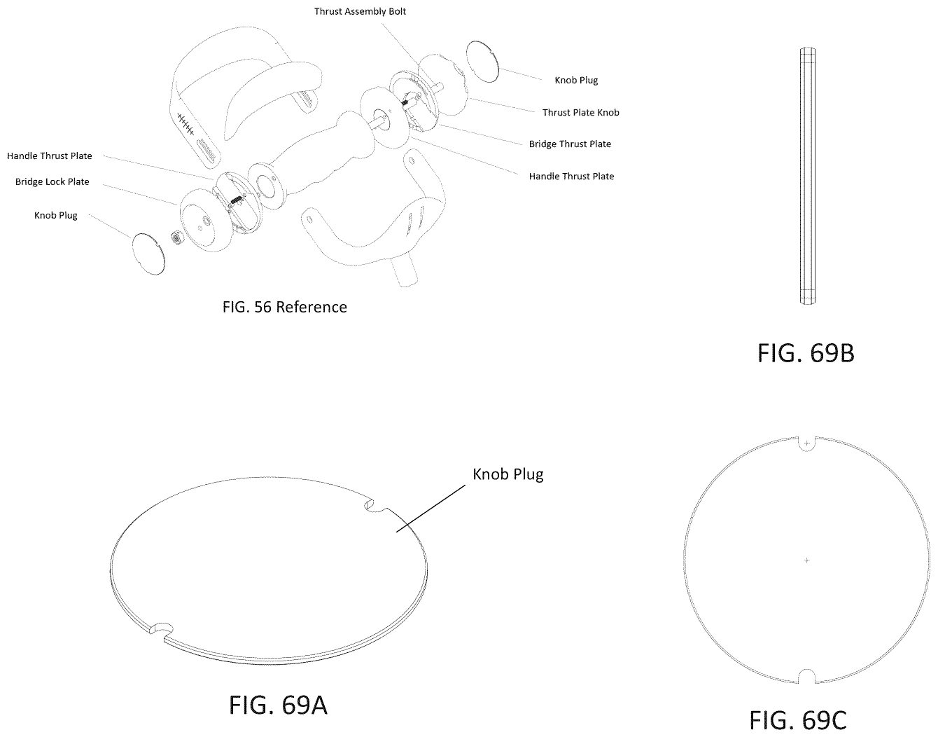

FIGS. 69A-69C show view of a knob plug according to some embodiments. In some embodiments, once the orbital frame is assembled, the knob plug acts as a cover and/or surface for decals, for example.

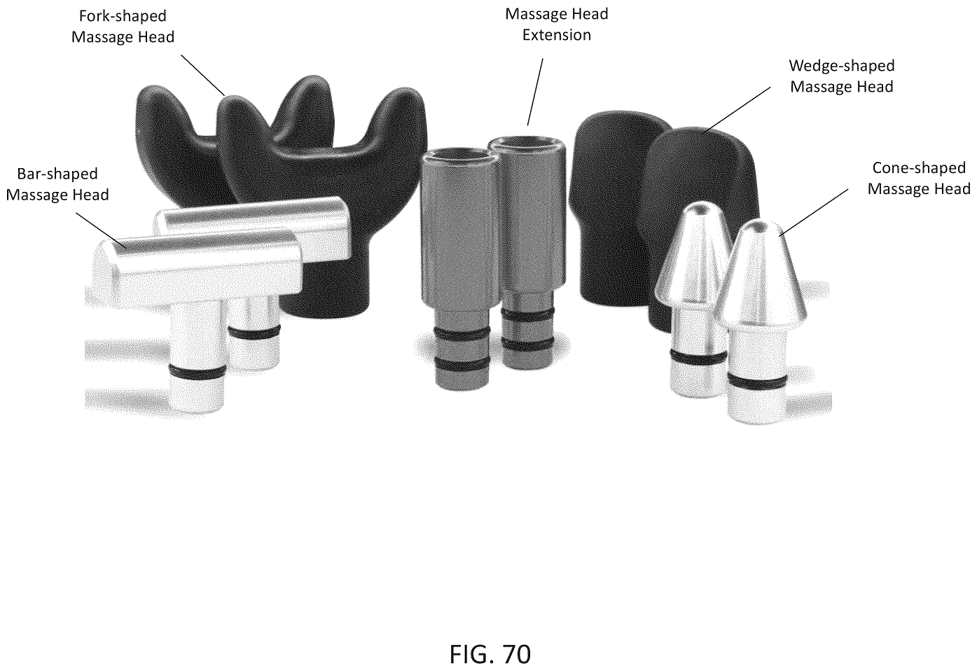

FIG. 70 shows various massage heads according to some embodiments. In some embodiments, massage head suitable for connection to the massage head stem include, but are not limited to, bar-shaped massage heads, fork-shaped massage heads, wedge shaped massage heads, and cone-shaped massage heads. In some embodiments, the system includes a kit with one or more frames and one or more massage heads described herein.

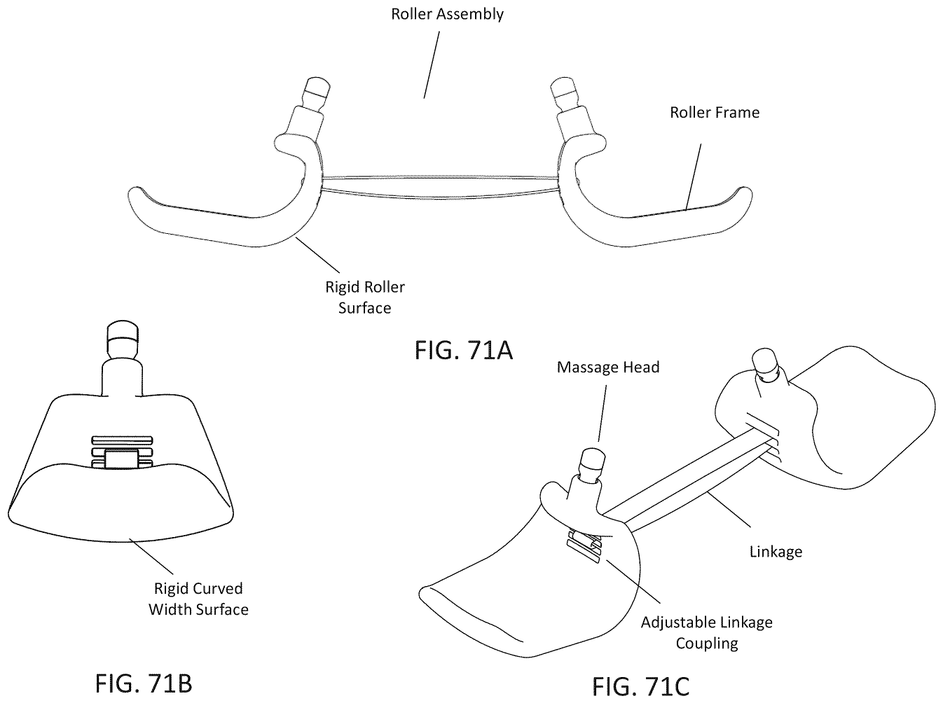

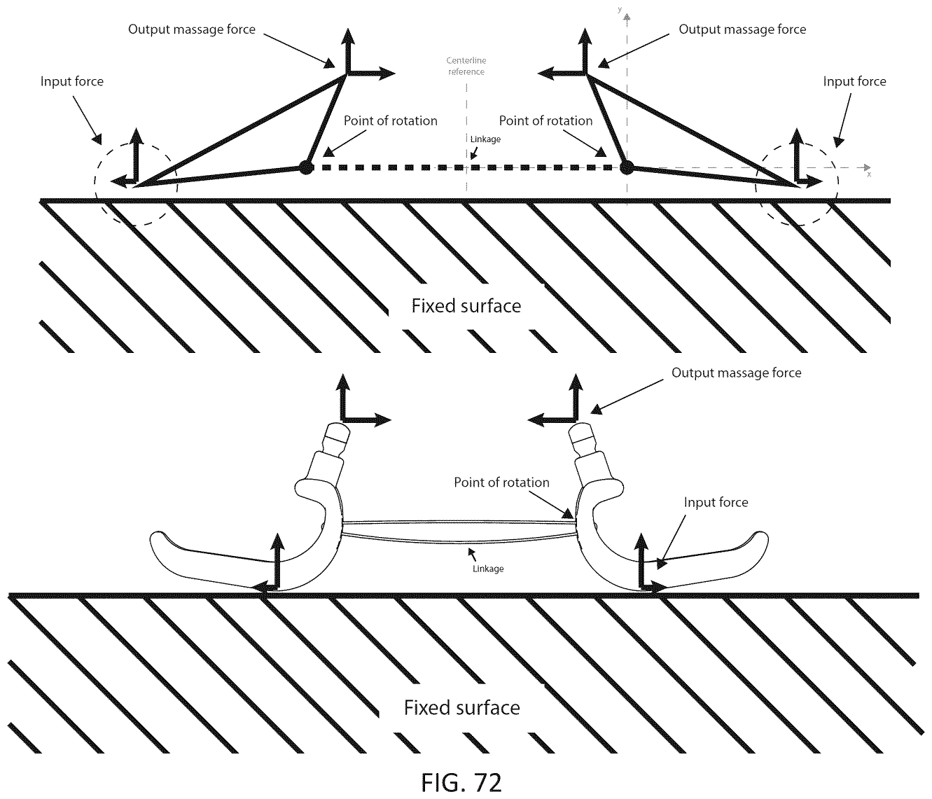

FIGS. 71A-71C illustrate various features of a roller assembly according to some embodiments. In some embodiments, the roller assembly is configured to enable a user to lay on the roller assembly while the roller assembly is placed on a fixed surface. In some embodiments, the downward pressure of the user is configured to cause rotation about the rigid roller surface resulting in a clamping motion of the massage heads towards each other. In some embodiments, a rigid curved width surface enable the user to move the massage heads to different lateral angles (i.e., orthogonal to the linkage). In some embodiments, the roller assembly includes adjustable linkage couplings, which in this non-limiting example include a plurality of slots. FIG. 72 illustrates resultant forces from a user laying on a roller frame assembly according to some embodiments.

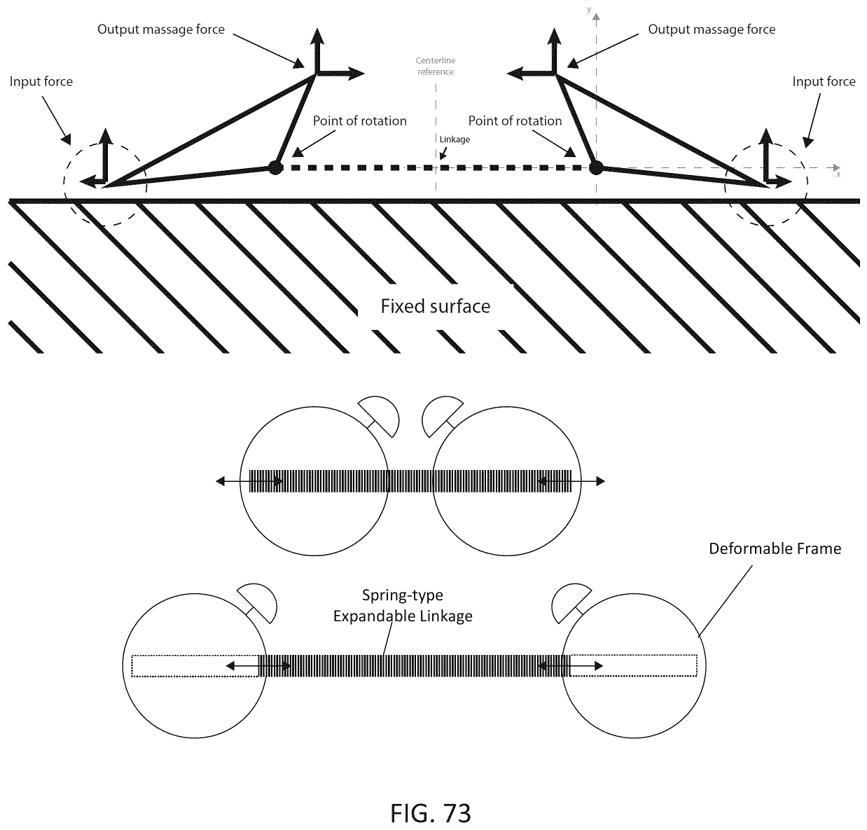

FIG. 73 illustrates resultant forces from a user laying on a deformable frame assembly according to some embodiments. In some embodiments, the resultant force is similar to the roller assembly, but the deformable frame (e.g., pillow structure) is configured to enable the massage heads to move vertically while the frame deforms (e.g., squishes). In some embodiments, the deformable frame also enable the massage heads to move orthogonal to the linkage. In some embodiments, the articulation of the frames is augmented and defined by a frame construction of non-homogenous material density, resulting in a augmentation of the center-of-gravity location of the respective frames.

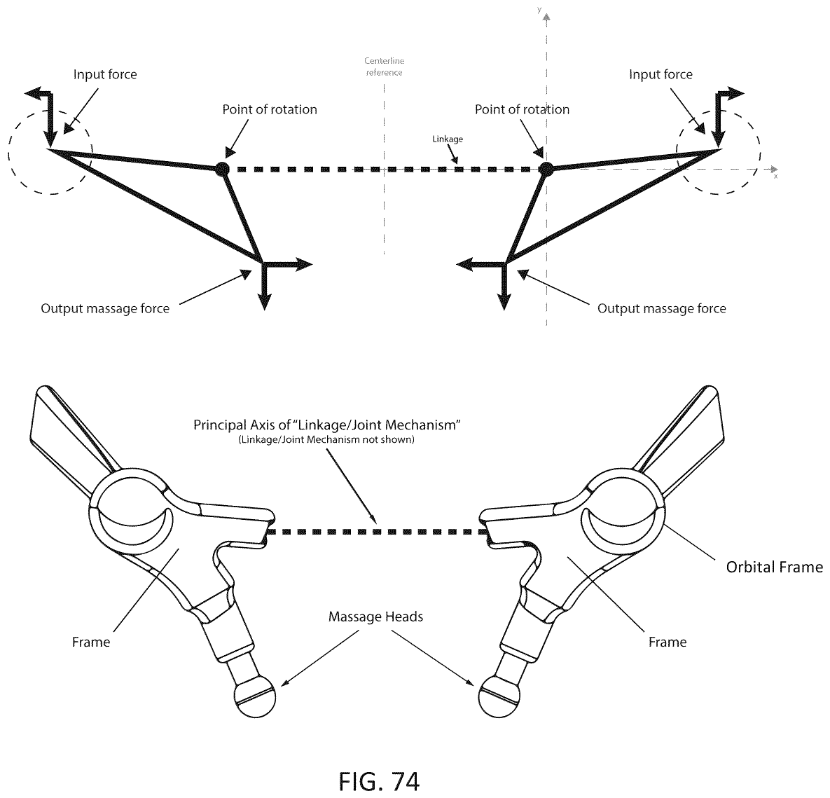

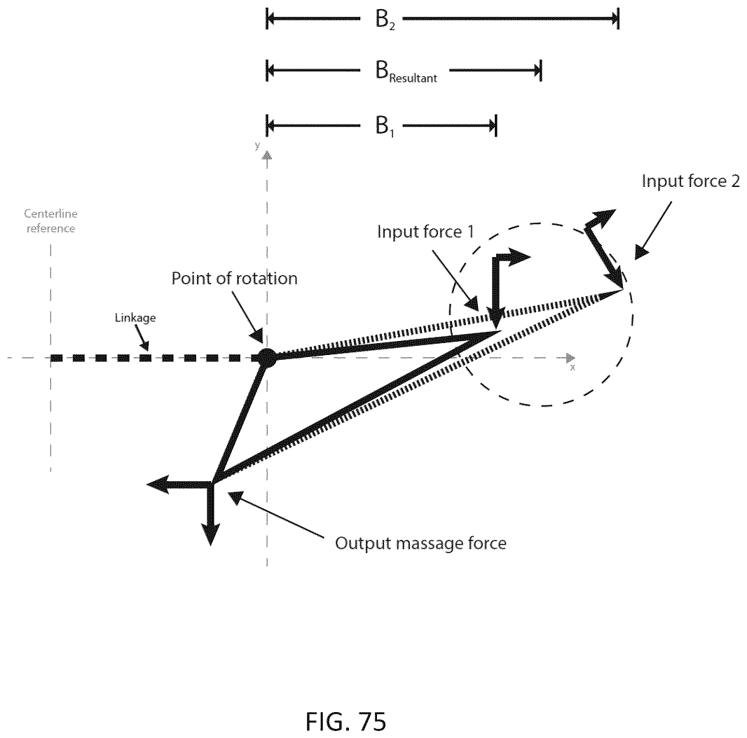

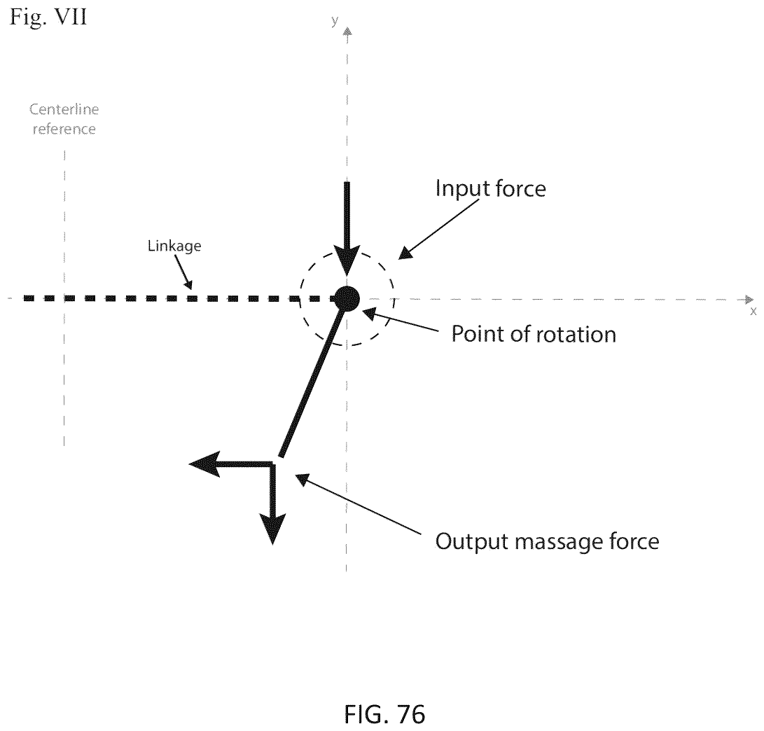

FIG. 74 illustrates resultant forces from a user pushing on the handles of an orbital frame assembly according to some embodiments. FIG. 75 shows the resulting force from force applied to both the handle and the BHS of an orbital frame according to some embodiments. FIG. 76 depicts the resulting force where an axis of the handle includes the point of rotation according to some embodiments.

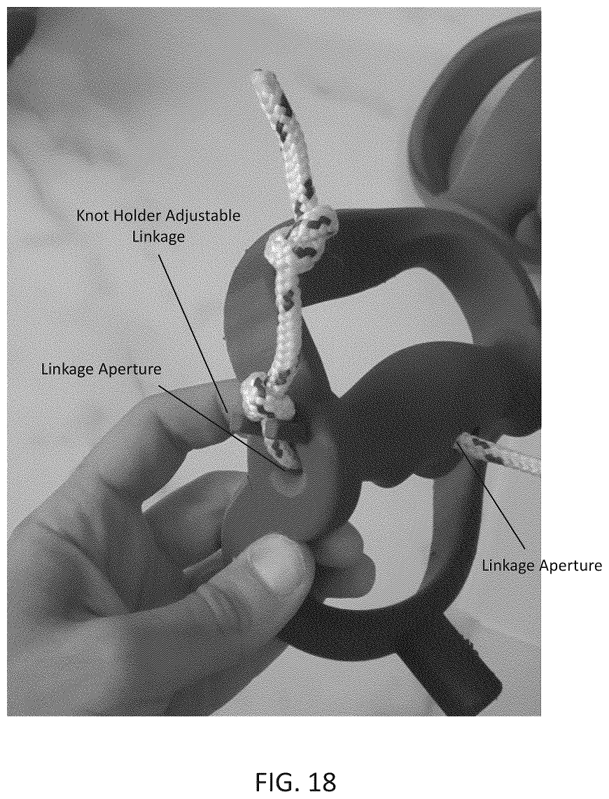

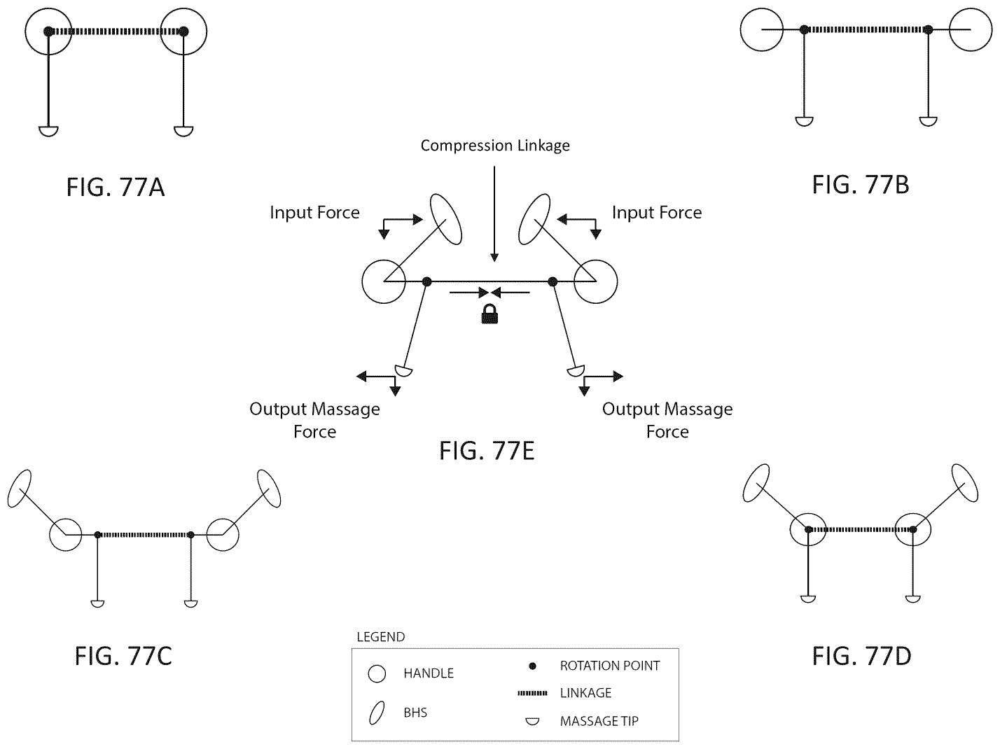

FIGS. 77A-77E shows various locations for components of a modular frame according to some embodiments. In some embodiments, the modular frame includes one or more handles, BHSs, linkages, bridges and massage tips. In some embodiments, the modular frame handle includes a linkage aperture (see FIG. 18, for example) configured to make the handle the point of rotation as shown in FIG. 77A. FIG. 77B shows attachment of a bridge configured to move the rotation point away from the handle along the axis of the linkage according to some embodiments. In some embodiments, the modular frame is configured to enable the attachment of a BHS to one or more massage tools as shown in FIG. 77C. FIG. 77D shows an arrangement where the rotation point is coincident with the handle and the BHSs are attached. In some embodiments, a modular frame includes an orbital frame. FIG. 77E shows an embodiment where the linkage includes a compressive linkage. In some embodiments, the compressive linkage is configured to enable the user to apply an outward diverging massage force beneficial for massaging of the respective lateral psoas muscle groups. In some embodiments, one or more frames described herein may include a compression linkage coupling (see FIG. 24) configured to attach a ridged compressive linkage.

The subject matter described herein are directed to technological improvements to the field of massage therapy. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the invention can also be defined as a machine that transforms data from one state to another state. The data can represent an article, which can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system comprising:
a first massage tool,
a second object, and
a linkage;
wherein the first massage tool includes a first linkage coupling;
wherein the second object includes a second linkage coupling; and
wherein the first massage tool is configured to be connected to the second object by connecting a first linkage end to the first linkage coupling and a second linkage end to the second object.

2. The system of claim 1,
wherein the first massage tool further includes:
a first force input location,
a first rotation point, and
a first massage location;
wherein a first input force applied to the first force input location is configured to apply tension to the linkage when the first massage location is supported by a first surface and the second linkage end is connected to the second object;
wherein the tension is configured to resist motion of the first rotation point in at least one direction; and
where the first force input location and the first massage location are configured to move relative to the first rotation point while the tension is applied to the linkage.

3. The system of claim 2,
wherein the first input force applied to the first force input location is configured to apply a parallel force to the first massage location.

4. The system of claim 3,
wherein the first input force applied to the first force input location is configured to apply a non-parallel force to the first massage location.

5. The system of claim 2,
wherein the first force input location is separated from the first rotation point by a first input distance;
wherein the first massage location is separated from the first rotation point by a first massage distance; and
wherein the first input distance is greater than the first massage distance.

6. The system of claim 2,
wherein the first force input location is located at a first input angle relative to the linkage when the linkage is in tension;
wherein the first massage location is located at a first massage angle relative to the linkage when the linkage is in tension; and
wherein the first input angle and the first massage angle are different angles.

7. The system of claim 2,
wherein the first input force applied along a y-axis to the first force input location is configured to cause a relative y-axis and x-axis force at the first massage location while the linkage is in tension.

8. The system of claim 2,
wherein lines extending from the first force input location, the first massage location, and the first rotation point create a triangular shape;
wherein a distance between the first force input location and the first massage location define a hypotenuse of the triangular shape; and
wherein applying the first input force is configured apply a resulting output force at the first massage location in a same direction as the hypotenuse while the linkage is in tension.

9. The system of claim 1,
wherein the first massage tool further includes:
a first force input location,
a first rotation point, and
a first massage location;
wherein the second object includes a second massage tool, wherein the second massage tool includes:
a second force input location,
a second rotation point, and
a second massage location;
wherein a first input force applied to the first force input location and a second input force applied to the second force input location is configured to apply tension to the linkage when the first massage location is supported by a first surface and the second massage location is supported by a second surface.

10. The system of claim 9,
wherein the first massage tool is configured to enable the first input force to be applied by a first hand; and
wherein the second massage tool is configured to enable the second input force to be applied by a second hand.

11. The system of claim 9,
wherein the first massage tool is configured to enable the first input force to be applied by a substantially rigid surface; and
wherein the second massage tool is configured to enable the second input force to be applied by the substantially rigid surface.

12. The system of claim 11,
wherein a user laying on the first massage tool and the second massage tool while the first massage tool and second massage tool are on the substantially rigid surface is configured to create the tension in the linkage.

13. The system of claim 12,
wherein a user laying on the first massage tool and second massage tool while the first massage tool and second massage tool are on the substantially rigid surface is configured to cause the first massage location and the second massage location to move toward each other while the linkage is in tension.

14. The system of claim 1,
wherein a length of the linkage is adjustable.

15. The system of claim 10,
wherein the first force input location includes a handle; and
wherein the first massage location includes a massage tip.

16. The system of claim 13,
wherein the first force input location includes a deformable curved surface; and
wherein the first massage location includes a rigid massage tip.

17. The system of claim 13,
wherein the first force input location includes a rigid curved surface; and
wherein the first massage location includes a rigid massage tip.

18. The system of claim 13,
further comprising a rack assembly comprising a first rack and a second rack;
wherein a plurality of first massage tools are coupled to the first rack; and
wherein a plurality of second massage tools are coupled to the second rack.
